(19) United States
(12) Patent Application Publication
(10) Pub. No.: US 2026/0231282 A1
(43) Pub. Date: Aug. 6, 2026

(54) METHOD AND APPARATUS FOR POWER SAVING IN WIRELESS COMMUNICATION SYSTEM

(71) Applicant: Samsung Electronics Co., Ltd., Suwon-si, Gyeonggi-do (KR)

(72) Inventors: Sa ZHANG, Beijing (CN); Feifei SUN, Beijing (CN)

(21) Appl. No.: 19/147,157

(22) PCT Filed: Jan. 11, 2024
(86) PCT No.: PCT/KR2024/000528

§ 371 Date: Jul. 10, 2025

(30) Foreign Application Priority Data
Jan. 11, 2023 (CN) 202310041836.5
Feb. 16, 2023 (CN) 202310179916.7
Feb. 24, 2023 (CN) 202310195785.1
May 12, 2023 (CN) 202310539942.6
Jan. 4, 2024 (CN) 202410017945.8

(51) Int. Cl. H04W 76/28; H04L 5/00

(52) U.S. Cl. CPC H04W 76/28; H04L 5/0044; H04L 5/0055

(57) ABSTRACT

The disclosure relates to a 5G or 6G communication system for supporting a higher data transmission rate. A method and an apparatus for power saving in a wireless communication system are provided. The method includes receiving configuration information for configuring a parameter related to one or more of cell discontinuous reception (DRX) and/or discontinuous transmission (DTX), receiving a downlink control information (DCI) format through a physical downlink control channel (PDCCH), and when the cell DRX and/or DTX is configured, performing a DRX operation on a first downlink signal and/or performing a DTX operation on a first uplink signal, where the DRX operation includes receiving the first downlink signal in a first time, and the DTX operation includes transmitting the first uplink signal in the first time, where the first time is determined based on the configuration information and the DCI format. The invention can enhance network power saving.

### TECHNICAL FIELD

The disclosure relates to the technical field of wireless communication, and more specifically, to a method and an apparatus for power saving in a wireless communication system.

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

### DISCLOSURE OF INVENTION

### Solution to Problem

A method performed by a terminal in a wireless communication system, comprising: receiving configuration information for configuring a parameter related to one or more of cell discontinuous reception (DRX) and/or discontinuous transmission (DTX); receiving a downlink control information (DCI) format through a physical downlink control channel (PDCCH); and when the cell DRX and/or DTX is configured, performing a DRX operation on a first downlink signal and/or performing a DTX operation on a first uplink signal, wherein the DRX operation includes receiving the first downlink signal in a first time, and the DTX operation includes transmitting the first uplink signal in the first time, wherein the first time is determined based on the configuration information and the DCI format.

A terminal in a wireless communication system, the terminal comprising: a transceiver; and a controller coupled to the transceiver and configured to: receive configuration information for configuring a parameter related to one or more of cell discontinuous reception (DRX) and/or discontinuous transmission (DTX); receive a downlink control information (DCI) format through a physical downlink control channel (PDCCH); and when the cell DRX and/or DTX is configured, perform a DRX operation on a first downlink signal and/or performing a DTX operation on a first uplink signal, wherein the DRX operation includes receiving the first downlink signal in a first time, and the DTX operation includes transmitting the first uplink signal in the first time, wherein the first time is determined based on the configuration information and the DCI format.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure, in which:

FIG. 1 illustrates a schematic diagram of an example wireless network according to some embodiments of the disclosure;

FIGS. 2A and 2B illustrate example wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a first transceiving node according to some embodiments of the disclosure;

FIG. 5 illustrates a block diagram of a second transceiving node according to some embodiments of the disclosure;

FIG. 6 illustrates a flowchart of a method performed by a base station according to some embodiments of the disclosure;

FIG. 7 illustrates a flowchart of a method performed by a UE according to some embodiments of the disclosure;

FIGS. 8A-8C illustrate some examples of uplink transmission timing according to some embodiments of the disclosure;

FIGS. 9A and 9B illustrate examples of time domain resource allocation tables according to some embodiments of the disclosure;

FIGS. 10A and 10B illustrate an example of transmitting an uplink channel at an active period according to some embodiments of the disclosure respectively;

FIGS. 11A and 11B illustrate an example of a timeline for dynamic indication according to some embodiments of the disclosure respectively;

FIGS. 12A and 12B illustrate an example of an active period according to some embodiments of the disclosure respectively;

FIGS. 13A and 13B illustrate a schematic diagram of HARQ-ACK feedback of an SPS PDSCH according to some embodiments of the disclosure respectively;

FIG. 14 illustrates a flowchart of a method performed by a terminal according to some embodiments of the disclosure; and

FIG. 15 illustrates a flowchart of a method performed by a base station according to some embodiments of the disclosure.

FIG. 16 illustrates a structure of a UE according to an embodiment of the disclosure.

FIG. 17 illustrates a structure of a base station according to an embodiment of the disclosure.

### MODE FOR THE INVENTION

According to at least one embodiment of the disclosure, a method performed by a terminal in a wireless communication system is provided. The method includes: receiving configuration information for configuring a parameter related to one or more of cell discontinuous reception (DRX) and/or discontinuous transmission (DTX); receiving a downlink control information (DCI) format through a physical downlink control channel (PDCCH); and when the cell DRX and/or DTX is configured, performing a DRX operation on a first downlink signal and/or performing a DTX operation on a first uplink signal, wherein the DRX operation includes receiving the first downlink signal in a first time, and the DTX operation includes transmitting the first uplink signal in the first time, wherein the first time is determined based on the configuration information and the DCI format.

In some implementations, for example, the DCI format includes a first DCI format that schedules or indicates reception of a second downlink signal, and the first time includes a time from a first reference time to a second reference time, wherein the first reference time is one of a time after a second time after an end time of the PDCCH, or a starting time of the second downlink signal, and the second reference time is an end time of the second downlink signal.

In some implementations, for example, the second time is configured by a base station or based on a capability reported by the terminal.

In some implementations, for example, the DCI format includes a first DCI format that schedules or indicates reception of a second downlink signal, wherein the first time is determined to include a time from a first symbol of the second downlink signal to a last symbol of the second downlink signal.

In some implementations, for example, the second downlink signal includes one or more of: a PDSCH that is not configured or indicated to be transmitted with repetitions; a PDSCH scheduled by the first DCI format; or a PDSCH scheduled by a first DCI format, wherein the first DCI format does not schedule multiple PDSCHs.

In some implementations, for example, the DCI format includes a second DCI format that schedules or indicates transmission of a second uplink signal, and the first time includes a time from a third reference time to a fourth reference time, wherein the third reference time is one of a time after a third time after an end time of the PDCCH, or a starting time of the second uplink signal, and the fourth reference time is an end time of the second uplink signal.

In some implementations, for example, the third time is configured by a base station or based on a capability reported by the terminal.

In some implementations, for example, the DCI format includes a second DCI format that schedules or indicates transmission of a second uplink signal, wherein the first time is a time from a first symbol of the second uplink signal to a last symbol of the second uplink signal.

In some implementations, for example, the second uplink signal includes one or more of: a PUSCH that is not configured or indicated to be transmitted with repetitions; a PUSCH scheduled by the first DCI format; or a PUSCH scheduled by the first DCI format, wherein the first DCI format does not schedule multiple PUSCHs.

In some implementations, for example, the first downlink signal includes one or more of: a physical downlink channel and/or a physical downlink signal satisfying a first predefined condition; a physical downlink channel and/or a physical downlink signal configured to be received by higher layer signaling; a semi-persistent scheduling (SPS) physical downlink shared channel (PDSCH); a PDSCH scheduled by a DCI format, wherein the PDSCH is configured or indicated to be transmitted with repetitions; a PDSCH scheduled by a DCI format, wherein the DCI format schedules multiple PDSCHs; a physical downlink control channel (PDCCH); a channel state information reference signal (CSI-RS); a phase tracking reference signal (PT-RS); or a positioning reference signal (PRS).

In some implementations, for example, for the physical downlink channel and/or the physical downlink signal, the first predefined condition includes one or more of: at least one of a starting time or an end time of the physical downlink channel and/or the physical downlink signal being the first time; the starting time and the end time of the physical downlink channel and/or the physical downlink signal being within the first time; at least one symbol of the physical downlink channel and/or the physical downlink signal being within the first time; or all symbols of the physical downlink channel and/or the physical downlink signal being within the first time.

In some implementations, for example, the first uplink signal includes one or more of: a physical uplink channel and/or a physical uplink signal satisfying a second predefined condition; a physical uplink channel and/or a physical uplink signal configured to be received by higher layer signaling; a configured grant (CG) physical uplink shared channel (PUSCH); a PUSCH scheduled by a DCI format, wherein the PUSCH is configured or indicated to be transmitted with repetitions; a PUSCH scheduled by a DCI format, wherein the DCI format schedules multiple PUSCHs; a sounding reference signal (SRS); a PUCCH with channel state information (CSI); a PUCCH with hybrid automatic repeat request-acknowledgement (HARQ-ACK); a physical random access channel (PRACH); or a PUCCH with a scheduling request (SR).

In some implementations, for example, the first uplink signal includes one or more physical uplink channels including a physical uplink control channel (PUCCH) or a physical uplink shared channel (PUSCH), wherein transmitting the uplink signal in the first time includes: resolving overlapping among the one or more physical uplink channels to determine one or more first physical uplink channels from the one or more physical uplink channels; determining one or more second physical uplink channels from the one or more first physical uplink channels based on one or more of an uplink and downlink frame structure or a cancellation indication, wherein the uplink and downlink frame structure is indicated by one or more of an uplink and downlink configuration or a third DCI format including a slot format indicator (SFI), and the cancellation indication is included in the third DCI format and used for indicating one or more resources where a transmission is cancelled; and transmitting a second physical uplink channel among the one or more second physical uplink channels that satisfies a second predefined condition.

In some implementations, for example, the first uplink signal includes one or more physical uplink channels including a PUCCH or a PUSCH, wherein transmitting the uplink signal in the first time includes: determining one or more third physical uplink channels satisfying a second predefined condition from the one or more physical uplink channels; resolving overlapping among the one or more third physical uplink channels to determine one or more fourth physical uplink channels from the one or more third physical uplink channels; determining at least one fourth physical uplink channel to be transmitted from the one or more fourth physical uplink channels based on one or more of an uplink and downlink frame structure or a cancellation indication, wherein the uplink and downlink frame structure is indicated by one or more of an uplink and downlink configuration or the first DCI format including an SFI, and the cancellation indication is included in the second DCI format and used for indicating one or more resources where a transmission is cancelled; and transmitting the at least one fourth physical uplink channel.

In some implementations, for example, the first uplink signal includes one or more physical uplink channels including a PUCCH or a PUSCH, wherein transmitting the uplink signal in the first time includes: determining one or more fifth physical uplink channels satisfying a second predefined condition and/or PUCCHs with repetitions from the one or more physical uplink channels; resolving overlapping among the one or more fifth physical uplink channels and/or the PUCCHs with repetitions to determine one or more sixth physical uplink channels from the one or more fifth physical uplink channels and/or the PUCCHs with repetitions; determining one or more seventh physical uplink channels from the one or more sixth physical uplink channels based on one or more of an uplink and downlink frame structure or a cancellation indication, wherein the uplink and downlink frame structure is indicated by one or more of an uplink and downlink configuration or the first DCI format including an SFI, and the cancellation indication is included in the second DCI format and used for indicating one or more resources where a transmission is cancelled; and transmitting a seventh physical uplink channel among the one or more seventh physical uplink channels that satisfies the second predefined condition.

In some implementations, for example, for the physical uplink channel and/or the physical uplink signal, the second predefined condition includes one or more of: at least one of a starting time or an end time of the physical uplink channel and/or the physical uplink signal being within the first time; the starting time and the end time of the physical uplink channel and/or the physical uplink signal being within the first time; at least one symbol of the physical uplink channel and/or the physical uplink signal being within the first time; or all symbols of the physical uplink channel and/or the physical uplink signal being within the first time.

In some implementations, for example, receiving the first downlink signal in the first time includes: when at least one symbol of the first downlink signal is not within the first time, receiving the first downlink signal in symbols other than the at least one symbol of the first downlink signal, and/or not receiving the first downlink signal in the at least one symbol of the downlink signal, and/or not receiving the first downlink signal.

In some implementations, for example, transmitting the first uplink signal in the first time includes: when at least one symbol of the first uplink signal is not within the first time, transmitting the first uplink signal in symbols other than the at least one symbol of the first uplink signal, and/or not transmitting the first uplink signal in the at least one symbol of the uplink signal, and/or not transmitting the first downlink signal.

In some implementations, for example, when the terminal is configured to receive one or more SPS PDSCHs, each of which is associated with a same uplink time unit (for example, HARQ-ACK information for each of the one or more SPS PDSCHs is to be transmitted or fed back on the same uplink time unit (e.g., slot)), in case that at least one of the one or more SPS PDSCHs is received in the first time, a HARQ-ACK codebook including HARQ-ACK information for each of the one or more SPS PDSCHs is generated.

In some implementations, for example, when the terminal is configured to receive one or more SPS PDSCHs, each of which is associated with a same uplink time unit (for example, HARQ-ACK information for each of the one or more SPS PDSCHs is to be transmitted or fed back on the same uplink time unit (e.g., slot)), in case that at least one of the one or more SPS PDSCHs is received in the first time, a HARQ-ACK codebook including HARQ-ACK information for the at least one of the one or more SPS PDSCHs is generated.

In some implementations, for example, when the terminal is configured to receive one or more SPS PDSCHs, each of which is associated with a same uplink time unit (for example, HARQ-ACK information for each of the one or more SPS PDSCHs is to be transmitted or fed back on the same uplink time unit (e.g., slot)), in case that the one or more SPS PDSCHs are not received in the first time, HARQ-ACK information for the one or more SPS PDSCHs is not generated.

In some implementations, for example, the parameter related to one or more of the cell DRX and/or DTX includes one or more of: a DRX cycle, a DTX cycle, a starting slot or a starting offset of DRX, a starting slot or a starting offset of DTX, the first time for the DRX or a DRX on-duration, the first time for the DTX or a DTX on-duration, information regarding one or more timers associated with the DRX, or information regarding one or more timers associated with the DTX.

According to at least one embodiment of the disclosure, a method performed by a base station in a wireless communication system is provided. The method includes: transmitting configuration information for configuring a parameter related to one or more of cell discontinuous reception (DRX) and/or discontinuous transmission (DTX) to a terminal; transmitting a downlink control information (DCI) format to the terminal through a physical downlink control channel (PDCCH); and when the cell DRX and/or DTX is configured for the terminal, performing a DTX operation on a first downlink signal and/or a DRX operation on a first uplink signal, wherein the DTX operation includes transmitting the first downlink signal in a first time, and the DRX operation includes receiving the first uplink signal in the first time, wherein the first time is determined based on the configuration information and the DCI format.

In some implementations, for example, the DCI format includes a first DCI format that schedules or indicates reception of a second downlink signal, and the first time includes a time from a first reference time to a second reference time, wherein the first reference time is one of a time after a second time after an end time of the PDCCH, or a starting time of the second downlink signal, and the second reference time is an end time of the second downlink signal.

In some implementations, for example, the second time is configured by a base station or based on a capability reported by the terminal.

In some implementations, for example, the DCI format includes a first DCI format that schedules or indicates reception of a second downlink signal, wherein the first time is determined to include a time from a first symbol of the second downlink signal to a last symbol of the second downlink signal.

In some implementations, for example, the second downlink signal includes one or more of: a PDSCH that is not configured or indicated to be transmitted with repetitions; a PDSCH scheduled by the first DCI format; or a PDSCH scheduled by a first DCI format, wherein the first DCI format does not schedule multiple PDSCHs.

In some implementations, for example, the DCI format includes a second DCI format that schedules or indicates transmission of a second uplink signal, and the first time includes a time from a third reference time to a fourth reference time, wherein the third reference time is one of a time after a third time after an end time of the PDCCH, or a starting time of the second uplink signal, and the fourth reference time is an end time of the second uplink signal.

In some implementations, for example, the third time is configured by the base station or based on a capability reported by the terminal.

In some implementations, for example, the DCI format includes a second DCI format that schedules or indicates transmission of a second uplink signal, wherein the first time is a time from a first symbol of the second uplink signal to a last symbol of the second uplink signal.

In some implementations, for example, the second uplink signal includes one or more of: a PUSCH that is not configured or indicated to be transmitted with repetitions; a PUSCH scheduled by the first DCI format; or a PUSCH scheduled by the first DCI format, wherein the first DCI format does not schedule multiple PUSCHs.

In some implementations, for example, the first downlink signal includes one or more of: a physical downlink channel and/or a physical downlink signal satisfying a first predefined condition; a physical downlink channel and/or a physical downlink signal configured to be received by higher layer signaling; a semi-persistent scheduling (SPS) physical downlink shared channel (PDSCH); a PDSCH scheduled by a DCI format, wherein the PDSCH is configured or indicated to be transmitted with repetitions; a PDSCH scheduled by a DCI format, wherein the DCI format schedules multiple PDSCHs; a physical downlink control channel (PDCCH); a channel state information reference signal (CSI-RS); a phase tracking reference signal (PT-RS); or a positioning reference signal (PRS).

In some implementations, for example, for the physical downlink channel and/or the physical downlink signal, the first predefined condition includes one or more of: at least one of a starting time or an end time of the physical downlink channel and/or the physical downlink signal being within the first time; the starting time and the end time of the physical downlink channel and/or the physical downlink signal being within the first time; at least one symbol of the physical downlink channel and/or the physical downlink signal being within the first time; or all symbols of the physical downlink channel and/or the physical downlink signal being within the first time.

In some implementations, for example, the first uplink signal includes one or more of: a physical uplink channel and/or a physical uplink signal satisfying a second predefined condition; a physical uplink channel and/or a physical uplink signal configured to be received by higher layer signaling; a configured grant (CG) physical uplink shared channel (PUSCH); a PUSCH scheduled by a DCI format, wherein the PUSCH is configured or indicated to be transmitted with repetitions; a PUSCH scheduled by a DCI format, wherein the DCI format schedules multiple PUSCHs; a sounding reference signal (SRS); a PUCCH with channel state information (CSI); a PUCCH with hybrid automatic repeat request-acknowledgement (HARQ-ACK); a physical random access channel (PRACH); or a PUCCH with a scheduling request (SR).

In some implementations, for example, the first uplink signal includes one or more physical uplink channels including a physical uplink control channel (PUCCH) or a physical uplink shared channel (PUSCH), wherein transmitting the uplink signal in the first time includes: resolving overlapping among the one or more physical uplink channels to determine one or more first physical uplink channels from the one or more physical uplink channels; determining one or more second physical uplink channels from the one or more first physical uplink channels based on one or more of an uplink and downlink frame structure or a cancellation indication, wherein the uplink and downlink frame structure is indicated by one or more of an uplink and downlink configuration or a third DCI format including a slot format indicator (SFI), and the cancellation indication is included in the third DCI format and used for indicating one or more resources where a transmission is cancelled; and transmitting a second physical uplink channel among the one or more second physical uplink channels that satisfies a second predefined condition.

In some implementations, for example, for the physical uplink channel and/or the physical uplink signal, the second predefined condition includes one or more of: at least one of a starting time or an end time of the physical uplink channel and/or the physical uplink signal being within the first time; the starting time and the end time of the physical uplink channel and/or the physical uplink signal being within the first time; at least one symbol of the physical uplink channel and/or the physical uplink signal being within the first time; or all symbols of the physical uplink channel and/or the physical uplink signal being within the first time.

In some implementations, for example, transmitting the first downlink signal in the first time includes: when at least one symbol of the first downlink signal is not within the first time, transmitting the first downlink signal in symbols other than the at least one symbol of the first downlink signal, and/or not transmitting the first downlink signal in the at least one symbol of the downlink signal, and/or not transmitting the first downlink signal.

In some implementations, for example, receiving the first uplink signal in the first time includes: when at least one symbol of the first uplink signal is not within the first time, receiving the first uplink signal in symbols other than the at least one symbol of the first uplink signal, and/or not receiving the first uplink signal in the at least one symbol of the uplink signal, and/or not receiving the first downlink signal.

In some implementations, for example, the parameter related to one or more of the cell DRX and/or DTX includes one or more of: a DRX cycle, a DTX cycle, a starting slot or a starting offset of DRX, a starting slot or a starting offset of DTX, the first time for the DRX or a DRX on-duration, the first time for the DTX or a DTX on-duration, information regarding one or more timers associated with the DRX, or information regarding one or more timers associated with the DTX.

According to at least one embodiment of the disclosure, a terminal in a wireless communication system is also provided. The terminal includes: a transceiver; and a controller coupled with the transceiver and configured to perform one or more of the operations in the above-mentioned methods performed by the terminal.

According to at least one embodiment of the disclosure, a base station in a wireless communication system is also provided. The base station includes: a transceiver; and a controller coupled with the transceiver and configured to perform one or more of the operations in the above-mentioned method performed by the base station.

According to at least one embodiment of the disclosure, a computer-readable storage medium having one or more computer programs stored thereon is also provided, wherein the one or more computer programs, when executed by one or more processors, can implement any of the above-described methods.

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

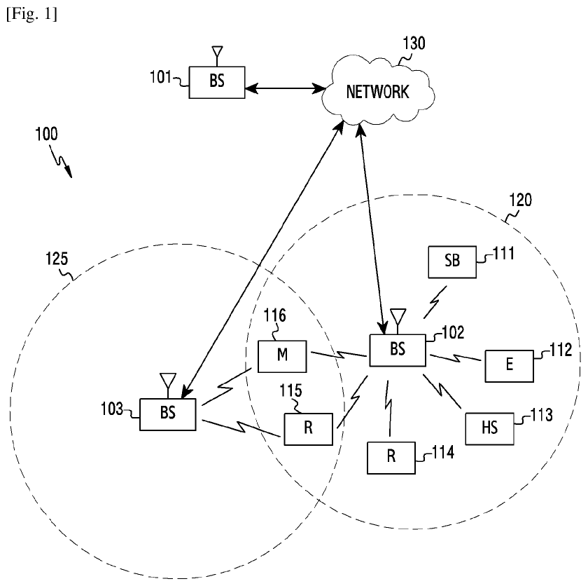

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

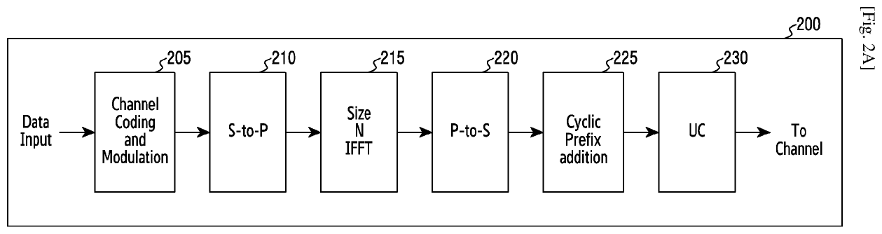

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

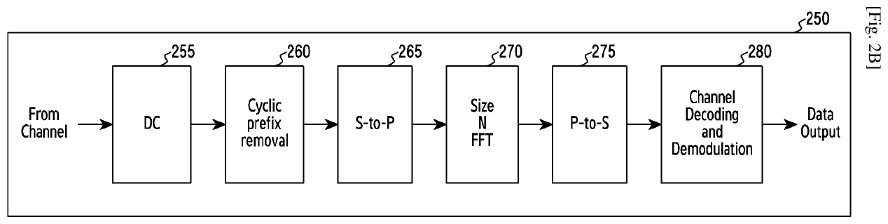

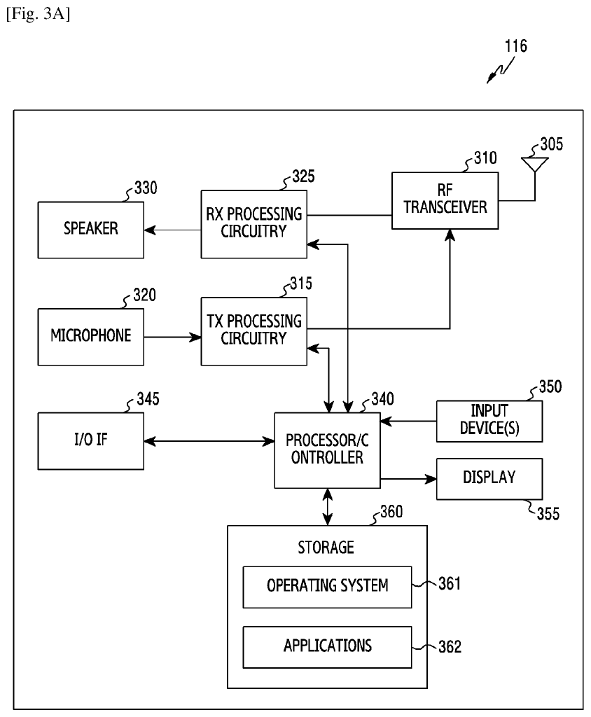

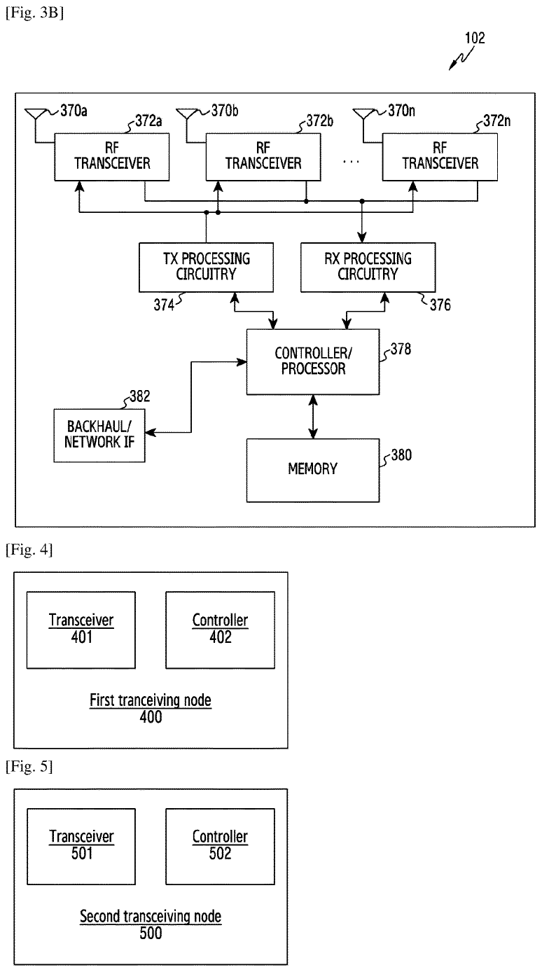

FIG. 3A illustrates an example UE 116 according to some embodiments of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In some implementations, two or more UEs 116 may communicate directly using one or more sidelink channels (for example, without using a base station as a medium for communication with each other). For example, the UE 116 may communicate using peer-to-peer (P2P) communication, device-to-device (D2D) communication, vehicle-to-everything (V2X) protocol (which, for example, may include vehicle-to-vehicle (V2V) protocol, vehicle-to-infrastructure (V2I) protocol, etc.), mesh network, etc. In this case, the UE 116 may perform scheduling operations, resource selection operations, and/or other operations performed by the base station as described elsewhere herein. For example, the base station may configure the UE 116 via downlink control information (DCI), radio resource control (RRC) signaling, medium access control-control element (MAC-CE) or via system information (e.g., system information block (SIB)).

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a settop box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. At present in ITU report ITU-R M. [IMT.VISION], the framework and overall goals of the future 5G has been discussed, in which the demand outlook, application scenarios and important performance indicators of 5G are described in detail. With respect to new requirements in 5G, ITU report ITU-R M. [IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot; for another example, a PDSCH time unit), the uplink time unit (for example, a PUCCH time unit) that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In some cases, when the base station is/operates in power saving, the UE may consume unnecessary power, so an enhanced downlink signal reception method or uplink signal transmission method of the UE is required to reduce the power consumption of the UE.

In order to at least solve the above technical problems, embodiments of the disclosure provide a method performed by a terminal (UE), the terminal (UE), a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. For another example, the embodiments of the disclosure may be applicable to the scenario of sidelink communication, in which case, the first transceiver node may be a UE, and the second transceiver node may be another UE. Therefore, the first transceiving node and the second transceiving node may each be any suitable communication node. In the following description, the base station is taken as an example (but not limited thereto) to illustrate the first transceiving node, and the UE is taken as an example (but not limited thereto) to illustrate the second transceiving node.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (CE).

In the following description of the disclosure, higher layer signaling may be signaling corresponding to at least one or a combination of one or more of the following signaling.
MIB (master information block)
SIB (system information block) or SIB X (X=1, 2, . . . )
RRC signaling
MAC CE

Physical layer (Layer 1 (L1)) signaling may be a signaling corresponding to at least one or a combination of one or more of the following signaling.
PDCCH (physical downlink control channel)
DCI (downlink control information)
UE-specific DCI
group common DCI
common DCI
scheduling DCI (for example, DCI for scheduling downlink or uplink data)
non-scheduling DCI (for example, DCI other than DCI for scheduling downlink or uplink data)
PUCCH (physical uplink control channel)
UCI (uplink control information)

In embodiments of the disclosure, uplink control signaling may include physical layer signaling and/or higher layer signaling. As described above, the physical layer signaling may include UCI and/or PUCCH, and the higher layer signaling may include RRC signaling and/or MAC CE.

In embodiments of the disclosure, downlink control signaling may include physical layer signaling and/or higher layer signaling. As mentioned above, the physical layer signaling may include one or more of PDCCH, DCI, UE-specific DCI, group common DCI, common DCI, scheduling DCI (for example, DCI for scheduling downlink or uplink data), and non-scheduling DCI, and the higher layer signaling may include one or more of MIB, SIB or SIB X (X=1, 2, . . . ), RRC signaling or MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

FIG. 4 illustrates a block diagram of a first transceiving node 400 according to some embodiments of the disclosure.

Referring to FIG. 4, the first transceiving node 400 may include a transceiver 401 and a controller 402.

The transceiver 401 may be configured to transmit first data and/or first control signaling to a second transceiving node, and/or receive second data and/or second control signaling from the second transceiving node in a time unit.

The controller 402 may be an application specific integrated circuit or at least one processor. The controller 402 may be configured to control the overall operation of the first transceiving node, including controlling the transceiver 401 to transmit the first data and/or the first control signaling to the second transceiving node and receive the second data and/or the second control signaling from the second transceiving node in the time unit.

In some implementations, the controller 402 may be configured to perform one or more of operations in methods of various embodiments described below, for example, operations that can be performed by a base station.

In the following description, a base station is taken as an example (but not limited thereto) to illustrate the first transceiving node, and a UE is taken as an example (but not limited thereto) to illustrate the second transceiving node. Downlink data (but not limited thereto) is used to illustrate the first data. Downlink control signaling (but not limited thereto) is used to illustrate the first control signaling. Uplink control signaling (but not limited thereto) is used to illustrate the second control signaling.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

FIG. 5 illustrates a block diagram of a second transceiving node according to some embodiments of the disclosure.

Referring to FIG. 5, the second transceiving node 500 may include a transceiver 501 and a controller 502.

The transceiver 501 may be configured to receive first data and/or first control signaling from the first transceiving node, and transmit second data and/or second control signaling to the first transceiving node in a determined time unit.

The controller 502 may be an application specific integrated circuit or at least one processor. The controller 502 may be configured to control the overall operation of the second transceiving node and control the second transceiving node to implement the methods proposed in the embodiments of the disclosure. For example, the controller 502 may be configured to determine the second data and/or the second control signaling and a time unit for transmitting the second data and/or the second control signaling based on the first data and/or the first control signaling, and control the transceiver 501 to transmit the second data and/or the second control signaling to the first transceiving node in the determined time unit.

In some implementations, the controller 502 may be configured to perform one or more of operations in methods of various embodiments described below, for example, operations that can be performed by a terminal (UE).

In implementations described in connection with FIG. 4 or 5, the first data may be data transmitted by the first transceiving node to the second transceiving node. In the following examples, downlink data carried by a PDSCH (Physical Downlink Shared Channel) is taken as an example (but not limited thereto) to illustrate the first data.

In implementations described in connection with FIG. 4 or 5, the second data may be data transmitted by the second transceiving node to the first transceiving node. In the following examples, uplink data carried by a PUSCH (Physical Uplink Shared Channel) is taken as an example to illustrate the second data, but not limited thereto.

In implementations described in connection with FIG. 4 or 5, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In implementations described in connection with FIG. 4 or 5, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information) or CG (Configured Grant) UCI. In embodiments of the disclosure, when UCI is carried by a PUCCH, the UCI may be used interchangeably with the PUCCH.

In some implementations, a PUCCH with an SR may be a PUCCH with a positive SR and/or negative a SR. The SR may be the positive SR and/or the negative SR.

In some implementations, the CSI may also be Part 1 CSI and/or Part 2 CSI.

In implementations described in connection with FIG. 4 or 5, a first time unit is a time unit in which the first transceiving node transmits the first data and/or the first control signaling. In some examples, a downlink time unit or downlink slot may be taken as an example (but not limited thereto) to illustrate the first time unit.

In implementations described in connection with FIG. 4 or 5, a second time unit is a time unit in which the second transceiving node transmits the second data and/or the second control signaling. In the following examples, an uplink time unit or uplink slot or PUCCH slot or PCell (Primary Cell) slot or PUCCH slot on PCell is taken as an example (but not limited thereto) to illustrate the second time unit. The “PUCCH slot” may be understood as a PUCCH transmission slot.

In embodiments of the disclosure, a time unit (for example, the first time unit or the second time unit) may be one or more slots, one or more subslots, one or more OFDM symbols, one or more spans, or one or more subframes.

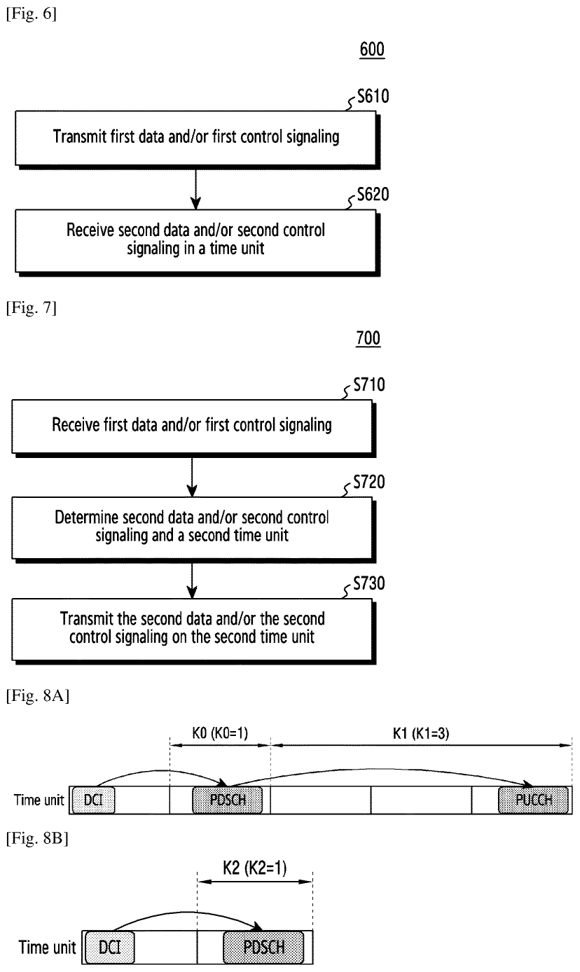

FIG. 6 illustrates a flowchart of a method 600 performed by a base station according to some embodiments of the disclosure.

Referring to FIG. 6, in operation S610, the base station transmits downlink data and/or downlink control information.

In operation S620, the base station receives uplink data and/or uplink control information from a UE in a time unit.

In some implementations, operations S610 and/or S620 may be performed based on the methods described according to various embodiments of the disclosure (e.g., various methods/manners described below).

In some implementations, the method 600 may omit one or more of operation S610 or S620, or may include additional operations, for example, the operations performed by the base station based on the methods described according to various embodiments of the disclosure (e.g., various methods/manners described below).

FIG. 7 illustrates a flowchart of a method 700 performed by a UE according to embodiments of the disclosure.

Referring to FIG. 7, in operation S710, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In operation S720, the UE determines uplink data and/or uplink control signaling and a second time unit based on the downlink data and/or downlink control signaling.

In operation S730, the UE transmits the uplink data and/or the uplink control signaling to the base station on the second time unit.

In some implementations, operations S710 and/or S720 and/or S730 may be performed based on the methods described according to various embodiments of the disclosure (e.g., various manners described below).

In some implementations, the method 700 may omit one or more of operation S710, S720 or S730, or may include additional operations, for example, the operations performed by the UE (terminal) based on the methods described according to various embodiments of the disclosure (e.g., various manners described below).

In some implementations, acknowledgement/negative acknowledgement (ACK/NACK) for downlink transmissions may be performed through HARQ-ACK.

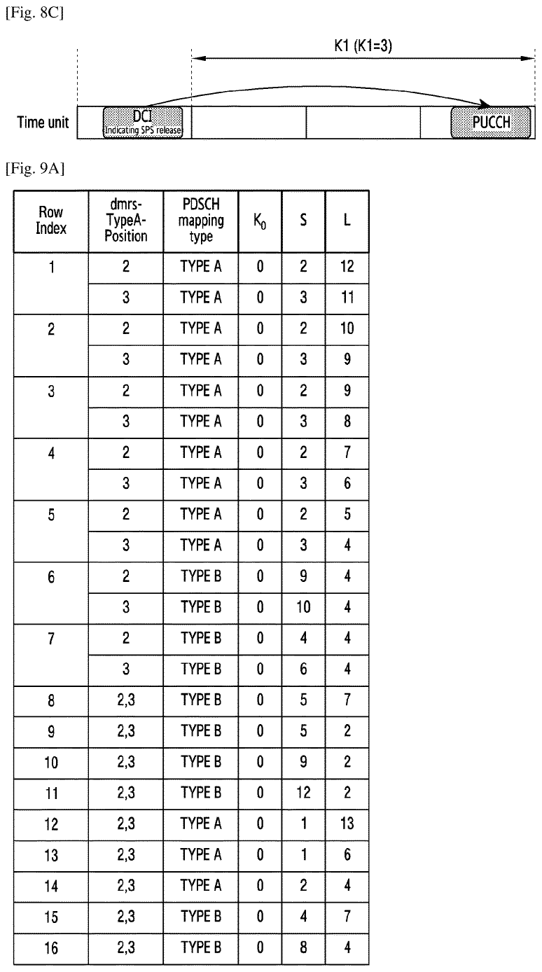

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 8A-8C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 8A gives an example in which K0=1. In the example illustrated in FIG. 8A, the time interval from the PDSCH scheduled by the DCI to the PDCCH carrying the DCI is one slot. In an embodiment of the disclosure, “a UE receives DCI” may mean that “the UE detects the DCI.”

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 8B gives an example in which K2=1. In the example illustrated in FIG. 8B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by a DCI) (e.g., may be referred to as DG (dynamic grant) PUSCH, in an embodiment of the disclosure) and/or a PUSCH not scheduled by a DCI (e.g., CG PUSCH).

In yet another example, the UE receives the PDSCH, and may transmit HARQ-ACK information for the PDSCH reception in a PUCCH in the second time unit. For example, a timing parameter (which may also be referred to as a timing value) K1 (e.g., the higher layer parameter dl-DataToUL-ACK) may be used to represent a time interval between the PUCCH for transmitting the HARQ-ACK information for the PDSCH reception and the PDSCH, and K1 may be in units of second time units, such as slots or subslots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 8A gives an example in which K1=3. In the example illustrated in FIG. 8A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K1, the timing parameter K0 may be used interchangeably with a timing parameter K0, and the timing parameter K2 may be used interchangeably with a timing parameter K2.

The PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by a DCI) and/or HARQ-ACK indicated by a DCI format (e.g., HARQ-ACK for a PDSCH reception scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the second time unit. For example, the timing parameter K1 may be used to represent a time interval between the PUCCH for transmitting the HARQ-ACK information for the DCI and the DCI, and K1 may be in units of second time units, such as slots or subslots. For example, FIG. 8C gives an example in which K1=3. In the example of FIG. 8C, the time interval between the PUCCH for transmitting the HARQ-ACK information for the DCI and the DCI is 3 slots. For example, the timing parameter K1 may be used to represent a time interval between a PDCCH reception carrying DCI indicating SPS PDSCH release (deactivation) and the PUCCH feeding back HARQ-ACK for the PDCCH reception.

In some implementations, in step S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission (for example, the UE is configured with the higher layer parameter PUCCH-ConfigurationList). For example, the UE may be configured to multiplex UCIs with different priorities via higher layer signaling (e.g., via higher layer parameter uci-Mux WithDiffPrio), otherwise (e.g., if the UE is not configured to multiplex UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority. In some embodiments of the disclosure, the terms “first priority”, “higher priority”, “greater priority index” and “priority index 1” may be used interchangeably. In embodiments of the disclosure, the terms “second priority”, “lower priority”, “smaller priority index” and “priority index 0” may be used interchangeably.

For example, multiplexing of multiple PUCCHs and/or PUSCHs overlapping in time domain may include multiplexing of UCI information of the PUCCH in a PUCCH or PUSCH.

For example, prioritizing of two PUCCHs and/or PUSCHs overlapping in time domain by the UE may include that the UE transmits the PUCCH or the PUSCH with the higher priority and/or the UE does not transmit the PUCCH or the PUSCH with the lower priority.

In some implementations, the UE may be configured with a subslot-based PUCCH transmission. For example, a subslot length parameter (which may also be referred to as a parameter with respect to a subslot length in embodiments of the disclosure) (e.g., the higher layer parameter subslotLengthForPUCCH) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of the PUCCH configuration parameter is one slot by default. If a subslot length parameter is configured in the PUCCH configuration parameter, the scheduling time unit of the PUCCH configuration parameter is L (L is the configured subslot configuration length) OFDM symbols.

The mechanism of slot-based PUCCH transmissions is basically the same as that of subslot-based PUCCH transmissions. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the higher layer parameter subslotLengthForPUCCH), unless otherwise indicated, a number of symbols contained in the slot of the PUCCH transmission is indicated by the subslot length parameter.

For example, if the UE is configured with the subslot length parameter, and subslot n is the last uplink subslot overlapping with a PDSCH reception or PDCCH reception (e.g., SPS PDSCH release, and/or indicating SCell dormancy, and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by one UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (which may be referred to as Group RNTI (G-RNTI) in embodiments of the disclosure) for scrambling of a dynamically scheduled multicast transmission (e.g., PDSCH) or an RNTI (which may be referred to as group configured scheduling RNTI (G-CS-RNTI) in embodiments of the disclosure) for scrambling of a multicast SPS transmission (e.g., SPS PDSCH). UCI(s) of the unicast PDSCH may include HARQ-ACK information, SR, or CSI of the unicast PDSCH reception. UCI(s) of the multicast PDSCH may include HARQ-ACK information for the multicast PDSCH reception. In embodiments of the disclosure, “multicast” may also be replaced by “broadcast”.

In some implementations, a HARQ-ACK codebook may include HARQ-ACK information for one or more PDSCHs and/or DCI. If the HARQ-ACK information for the one or more PDSCHs and/or DCI is transmitted in a same second time unit, the UE may generate the HARQ-ACK codebook based on a predefined rule. For example, if a PDSCH is successfully decoded, the HARQ-ACK information for the PDSCH reception is positive ACK. The positive ACK may be represented by 1 in the HARQ-ACK codebook, for example. If a PDSCH is not successfully decoded, the HARQ-ACK information for the PDSCH reception is Negative ACK (NACK). NACK may be represented by 0 in the HARQ-ACK codebook, for example. For example, the UE may generate the HARQ-ACK codebook based on the pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH reception. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of the SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that, in embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’. “‘A’ overlaps with ‘B’” may mean that ‘A’ overlaps with ‘B’ in time domain and/or ‘A’ overlaps with ‘B’ in frequency domain.

In some implementations, if HARQ-ACK information transmitted in a same second time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same second time unit only includes HARQ-ACK information for one or more SPS PDSCHs receptions, the UE may generate HARQ-ACK information (e.g., HARQ-ACK information only for SPS PDSCH receptions) according to a rule for generating a HARQ-ACK codebook for SPS PDSCHs. The UE may multiplex the HARQ-ACK information only for SPS PDSCH receptions in a specific PUCCH resource. For example, if the UE is configured with a PUCCH list parameter for SPS (e.g., SPS-PUCCH-AN-List), the UE multiplexes the HARQ-ACK information only for SPS PDSCH receptions in a PUCCH of a PUCCH list for SPS. For example, the UE determines a PUCCH resource in the PUCCH list for the SPS according to a number of HARQ-ACK information bits. If the UE is not configured with the PUCCH list parameter for SPS, the UE multiplexes the HARQ-ACK information only for SPS PDSCH receptions in a PUCCH resource specific to SPS HARQ-ACK (for example, the PUCCH resource is configured by the parameter n1PUCCH-AN).

In some implementations, if the HARQ-ACK information transmitted in the same second time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook) or a dynamic HARQ-ACK codebook (e.g., Type-2 HARQ-ACK codebook in 3GPP) according to a PDSCH HARQ-ACK codebook configuration parameter (e.g., the higher layer parameter pdsch-HARQ-ACK-Codebook). The dynamic HARQ-ACK codebook may also be an enhanced dynamic HARQ-ACK codebook (e.g., Type-2 HARQ-ACK codebook based on grouping and HARQ-ACK retransmission). The UE may multiplex the HARQ-ACK information in a PUCCH resource for HARQ-ACK associated with dynamically scheduling, which may be configured in a resource set list parameter (e.g., the parameter resourceSetToAddModList). The UE determines a PUCCH resource set (e.g., the parameter PUCCHResourceSet) in a resource set list according to a number of HARQ-ACK information bits, and the PUCCH resource may be determined as a PUCCH in the PUCCH resource set according to a PRI (PUCCH Resource Indicator) field indication in the last DCI format.

In some implementations, if the HARQ-ACK information transmitted in the same second time unit includes only HARQ-ACK information for SPS PDSCHs (e.g., a PDSCH not scheduled by a DCI format), the UE may generate the HARQ-ACK codebook according to a rule for generating a HARQ-ACK codebook for SPS PDSCH receptions (e.g., the pseudo code of a HARQ-ACK codebook for SPS PDSCH receptions).

The semi-static HARQ-ACK codebook (e.g., Type-1 HARQ-ACK codebook), may determine the size of the HARQ-ACK codebook and an order of HARQ-ACK bits according to a semi-statically configured parameter (e.g., a parameter configured by higher layer signaling). For a serving cell c, an active downlink BWP (bandwidth part) and an active uplink BWP, the UE determines a set of M_{A,c} occasions for candidate PDSCH receptions for which the UE can transmit corresponding HARQ-ACK information in a PUCCH in an uplink slot n_{U}.
M_{A,c} may be determined by at least one of:
a) HARQ-ACK slot timing values K1 of the active uplink BWP;
b) a downlink time domain resource allocation (TDRA) table;
c) an uplink SCS configuration and a downlink SCS configuration;
d) a semi-static uplink and downlink frame structure configuration;

$${N}_{slot , offset , c}^{DL} )$$

for the serving cell c and its corresponding slot offset SCS (e.g., the higher layer parameter μ_{offset,DL,c}), and a slot offset parameter (e.g., the higher layer parameter

$${N}_{slot , offset}^{UL} )$$

for a primary serving cell and its corresponding slot offset SCS (e.g., the higher layer parameter μ_{offset, UL}).

The parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlap with the candidate uplink slot in time domain. It should be noted that, in embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back is determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by a DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a starting OFDM symbol is 0 and an OFDM symbol length is 4; for the second row of the time domain resource allocation table, the starting OFDM symbol is 4 and the OFDM symbol length is 4; and for the third row of the time domain resource allocation table, the starting OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

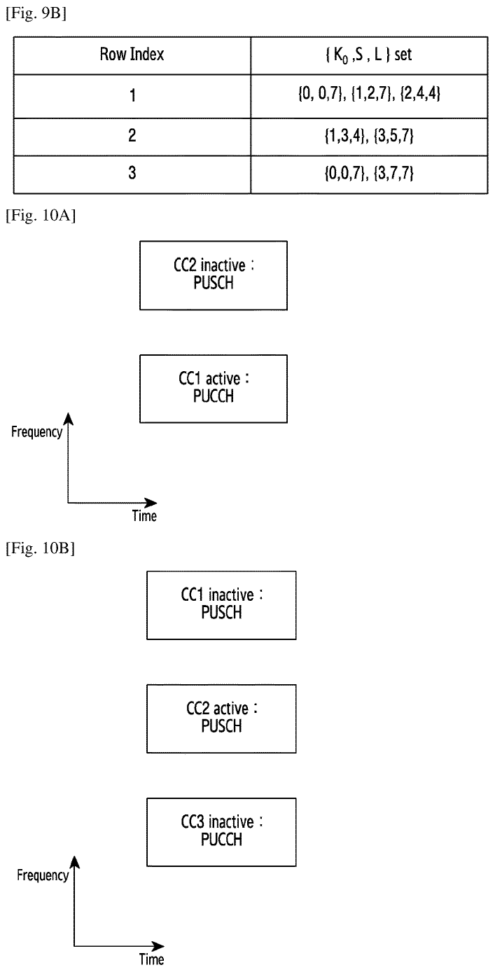

FIGS. 9A and 9B illustrate examples of time domain resource allocation tables. Specifically, FIG. 9A illustrates a time domain resource allocation table in which one PDSCH is scheduled in one row, and FIG. 9B illustrates a time domain resource allocation table in which multiple PDSCHs are scheduled in one row. Referring to FIG. 9A, each row corresponds to a set of {K0, mapping type, SLIV}, which includes a timing parameter K0 value, a mapping type, and an SLIV. Referring to FIG. 9B, unlike FIG. 9A, each row corresponds to multiple sets of {K0, mapping type, SLIV}.

In some implementations, the dynamic HARQ-ACK codebook (e.g., Type-2 HARQ-ACK codebook) and/or the enhanced dynamic HARQ-ACK codebook (e.g., Type-2 HARQ-ACK based on grouping and HARQ-ACK retransmission) may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a C-DAI (Counter-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, C-DAI may refer to: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a T-DAI (Total-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m} or V_{C-DAI,c,m} or

$${V}_{T - DAI}^{U L} .$$

Numbers of bits of the C-DAI and T-DAI are limited.

For example, in case that a C-DAI or T-DAI in a DCI is represented with 2 bits, the value of the C-DAI or T-DAI in the DCI may be determined by equations in Table 1. V_{T-DAI,m} or

$${V}_{T - DAI}^{U L}$$

is the value of the T-DAI in the DCI received in a PDCCH Monitoring Occasion (MO) m, and V_{C-DAI,c,m} is the value of the C-DAI in the DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| | V_{T-DAI,m} or | |
|---|---|---|
| MSB, LSB of | V_{C-DAI,c,m} or | |
| DAI Field | ${V}_{T - DAI}^{UL}$ | Y |
| 0,0 | 1 | (Y − 1) mod 4 + 1 = 1 |
| 0,1 | 2 | (Y − 1) mod 4 + 1 = 2 |
| 1,0 | 3 | (Y − 1) mod 4 + 1 = 3 |
| 1,1 | 4 | (Y − 1) mod 4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in case that the C-DAI or T-DAI in the DCI is 1 bit, values greater than 2 may be represented by equations in Table 2.

TABLE 2

| | V_{T-DAI, m} or | |
|---|---|---|
| DAI field | V_{C-DAI, c, m} | Y |
| 0 | 1 | (Y − 1) mod 2 + 1 = 1 |
| 1 | 2 | (Y − 1) mod 2 + 1 = 2 |

In some implementations, whether to feed back HARQ-ACK information may be configured by higher layer parameters or dynamically indicated by a DCI. The mode of feeding back (or reporting) the HARQ-ACK information (HARQ-ACK feedback mode or HARQ-ACK reporting mode) may also be at least one of the following modes.
HARQ-ACK feedback mode 1: transmitting ACK or NACK (ACK/NACK). For example, for a PDSCH reception, if the UE decodes a corresponding transport block (TB) correctly, the UE transmits ACK; and/or, if the UE does not decode the corresponding transport block correctly, the UE transmits NACK. For example, a HARQ-ACK information bit of the HARQ-ACK information provided according to the HARQ-ACK feedback mode 1 is an ACK value or a NACK value.
HARQ-ACK feedback mode 2: transmitting NACK only (NACK-only). For example, for a PDSCH reception, if the UE decodes the corresponding transport block correctly, the UE does not transmit the HARQ-ACK information; and/or, if the UE does not decode the corresponding transport block correctly, the UE transmits NACK. For example, at least one HARQ-ACK information bit of the HARQ-ACK information provided according to the HARQ-ACK feedback mode 2 is a NACK value. For example, for the HARQ-ACK feedback mode 2, the UE does not transmit a PUCCH that would include only HARQ-ACK information with ACK values.

In some implementations, a PUSCH conflicting with other physical channel(s) may be at least one of:
the PUSCH overlapping in time domain with other PUSCH(s) and/or PUCCH(s) and/or PDSCH(s) and/or PDCCH(s) on a same serving cell.
the PUSCH overlapping in time domain with a PUCCH. For example, the PUSCH overlaps in time domain with a PUCCH on a different serving cell, and/or the serving cell does not support simultaneous transmission of the PUSCH and the PUCCH.
In some implementations, a PDSCH conflicting with other physical channel(s) may be at least one of:
the PDSCH overlapping in time domain with other PUSCH(s) and/or PUCCH(s) and/or PDSCH(s) on a same serving cell.
the PDSCH overlapping in both time domain and frequency domain with a PDCCH on a same serving cell.

In some implementations, a PUCCH conflicting with other physical channel(s) may be at least one of:
the PUCCH overlapping in time domain with other PUCCH(s) and/or PUSCH(s).
the PUCCH overlapping in time domain with other PDSCH(s) on a same serving cell.

In some implementations, a PDCCH conflicting with other physical channel(s) may be at least one of:
the PDCCH overlapping in time domain with other PUSCH(s) and/or PUCCH(s) on a same serving cell.
the PDCCH overlapping in both time domain and frequency domain with other PDSCH(s) on a same serving cell.

In some implementations, “a set of overlapping channels” may be understood as that each channel of the set of overlapping channels overlaps (or conflicts) with at least one of channels in the set except this channel. The channels may include one or more PUCCHs and/or one or more PUSCHs. For example, “a set of overlapping channels” may include “a set of overlapping PUCCHs and/or PUSCHs”. As a specific example, when a first PUCCH overlaps with at least one of a second PUCCH and a third PUCCH, the second PUCCH overlaps with at least one of the first PUCCH and the third PUCCH, and the third PUCCH overlaps with at least one of the first PUCCH and the second PUCCH, the first PUCCH, the second PUCCH and the third PUCCH constitute a set of overlapping channels (PUCCHs). For example, the first PUCCH overlaps with the second PUCCH and the third PUCCH, and the second PUCCH and the third PUCCH do not overlap.

It should be noted that, in embodiments of the disclosure, “resolving overlapping channels” may be understood as resolving the conflict of overlapping channels. For example, when a PUCCH overlaps with a PUSCH, resolving the overlapping or conflict may include multiplexing UCI of the PUCCH in the PUSCH, or may include transmitting the PUCCH or PUSCH with a higher priority. For another example, when a PUCCH overlaps with one or another PUCCH, resolving the overlapping or conflict may include multiplexing UCI in a PUCCH, or may include transmitting the PUCCH with a higher priority. For yet another example, when two PUSCHs on a same serving cell overlap, resolving the overlapping or conflict may include transmitting a PUSCH with a higher priority of the two PUSCHs.

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be PDCCH and/or DCI and/or DCI format. For example, SPS PDSCH and/or CG PUSCH may be dynamically indicated in a corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, the parameters in the embodiments of the disclosure may be higher layer parameters. For example, the higher layer parameters may be parameters configured or indicated by higher layer signaling (e.g., RRC signaling).

It should be noted that, a PCell (Primary Cell) or PSCell (Primary Secondary Cell) in embodiments of the disclosure may be used interchangeably with a cell having a PUCCH. A serving cell may be used interchangeably with a cell.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured with and/or indicated a transmission with repetitions” may be understood that a number of the repetitions of the transmission is greater than 1. For example, “configured with and/or indicated a PUCCH transmission with repetitions” may be understood that “the PUCCH transmission is repeated on more than one slot/sub-slot”. “Not configured with and/or indicated a transmission with repetitions” may be understood that a number of the repetitions of the transmission is equal to 1. For example, “not configured with and/or indicated a PUCCH transmission with repetitions” may be understood that “a number of the repetitions of the PUCCH transmission is equal to 1”. For example, the UE may be configured with a parameter

$${N}_{PUCCH}^{repeat}$$

related to a number of repetitions of a PUCCH transmission; When the parameter

$${N}_{PUCCH}^{repeat}$$

is greater than 1, it may mean that the UE is configured with a PUCCH transmission with repetitions, and the UE may repeat the PUCCH transmission on

$${N}_{PUCCH}^{repeat}$$

time units (e.g., slots); when the parameter is equal to 1, it may mean that the UE is not configured with a PUCCH transmission with repetitions. For example, the PUCCH with repetitions may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, the multiple manners described in the disclosure may be combined in any order. In a combination, a manner may be performed one or more times.

It should be noted that, steps of methods of the disclosure may be implemented in any order.

It should be noted that, in embodiments of the disclosure, “canceling a transmission” may mean canceling the transmission of the entire uplink channel and/or cancelling the transmission of a part of the uplink channel.

It should be noted that, in embodiments of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in embodiments of the disclosure, a PUCCH/PUSCH carrying/with A may be understood as a PUCCH/PUSCH only carrying/with A, and may also be understood as a PUCCH/PUSCH carrying/with at least A.

It should be noted that, in embodiments of the disclosure, “slot” may be replaced by “subslot” or “time unit”.

It should be noted that, in embodiments of the disclosure, “performing a predefined method (or step) if a predefined condition is satisfied” and “not performing the predefined method (or step) if the predefined conditions is not satisfied” may be used interchangeably. “Not performing a predefined method (or step) if a predefined condition is satisfied” and “performing the predefined methods (or step) if the predefined condition is not satisfied” may be used interchangeably.

In some cases, in order to reduce the power/energy consumption of the base station, the base station may operate in a power/energy saving mode (for example, cell off mode; for another example, inactive mode) or dormancy mode or predetermined mode (in embodiments of the disclosure, the modes can be called “mode related to network power saving”). For example, in the power saving mode or dormancy mode or predetermined mode, the base station does not transmit a specific downlink signal and/or the base station does not receive a specific uplink signal.

In some implementations, the operating mode of the base station and/or the operating mode (or state) of the UE and/or parameters related to cell discontinuous reception (DRX) and/or discontinuous transmission (DTX) (for example, whether it is in the power saving mode; for another example, DRX/DTX mode) may be specified by protocols and/or configured by higher layer signaling and/or indicated by dynamic signaling. For example, there can be the following two modes, Mode 1 and Mode 2.

Mode 1 (in embodiments of the disclosure, it may also be called “first mode”): for example, Mode 1 may be a non-power saving mode (also called a normal mode) or an active mode. In Mode 1, normal communication (uplink and/or downlink transmission) may be performed between the base station and the UE. For example, when in mode 1, the base station may transmit a downlink channel and/or the base station may receive an uplink channel. Or, when in Mode 1, the UE may receive a downlink channel transmitted by the base station and/or the UE may transmit an uplink channel. It should be noted that Mode 1 may be an existing mode. Being in Mode 1 may be understood as being in a time (or state) of Mode 1, for example, being in an active period (or state).

Mode 2 (in embodiments of the disclosure, it may also be called “second mode”): for example, Mode 2 may be a power saving mode or a dormancy mode or an inactive mode. In Mode 2, the base station may not perform some or all downlink transmissions or uplink receptions. For example, when in Mode 2, the base station may not transmit some or all downlink channels and/or the base station may not receive some or all uplink channels, and correspondingly, the UE may not receive some or all downlink channels and/or the UE may not transmit some or all uplink channels. Or, when in Mode 2, the UE does not expect the base station to transmit some or all downlink channels and/or the base station to receive some or all uplink channels. Being in Mode 2 may be understood as being in a time (or state) of Mode 2, for example, being in a non-active period (or state). For another example, being in Mode 2 may be understood as being in a DRX and/or DTX opportunity.

In some implementations, the UE may be configured with and/or indicated a mode or state that is applicable to downlink reception and/or uplink transmission of the UE. For example, a mode or state may be configured and/or indicated to the UE in a serving cell, where the mode or state is applicable to downlink reception and uplink transmission of the UE in the serving cell. The behaviors (e.g., downlink reception methods and/or uplink transmission methods) of the UE in the mode may also be specified by protocols.

In some implementations, a mode or state may be configured and/or indicated separately for downlink reception and uplink transmission of the UE. For example, a downlink mode or state corresponding to downlink reception and an uplink mode or state corresponding to uplink transmission may be configured. For another example, for a serving cell in TDD band, a mode or state may be configured and/or indicated separately for downlink reception and uplink transmission of the UE. Or, a mode or state may be configured and/or indicated for downlink reception or uplink transmission of the UE. For example, for a serving cell in FDD band, a mode or state may be configured and/or indicated for downlink reception or uplink transmission of the UE. The behaviors of the UE in a downlink mode or state (e.g., downlink reception method) and/or the behaviors of the UE in an uplink mode (e.g., uplink transmission method) may also be specified by protocols. The UE may also report a UE capability regarding whether the UE supports a corresponding power saving mode separately for downlink reception and uplink transmission.

It should be noted that embodiments of the disclosure can be applied to one serving cell as well as multiple serving cells.

It should be noted that configuring and/or indicating a mode or state in embodiments of the disclosure may be understood as configuring one or more parameters related to network power saving and/or cell DRX and/or DTX. The one or more parameters related to network power saving and/or cell DRX and/or DTX may include at least one of a cycle, a starting slot (or offset), an active period duration, and a timer (e.g., one or more timers). The cell DRX and/or DTX may be understood as cell-specific DRX and/or DTX. The cell DRX and/or DTX may be DRX and/or DTX common to the UEs in the cell. The term “cell DRX and/or DTX” may refer to DRX and/or DTX of a cell or a corresponding base station, and/or DRX and/or DTX of a terminal. It should be noted that the term “cell DRX and/or DTX” used in the disclosure is only an example, and any suitable term may be used to represent transmission and/or reception related to power saving and/or DRX and/or DTX of the base station and/or the terminal.

In some cases, the UE may be configured with one or more parameters related to network power saving and/or cell DRX and/or DTX (for example, parameters related to Mode 1 and/or Mode 2 described above, or cell DRX and/or DTX parameters). In some examples, when the UE (e.g., a MAC entity) is configured with the parameters related to Mode 1 and/or Mode 2, the UE may have an active period corresponding to Mode 1 and/or a non-active period corresponding to Mode 2. In some examples, when the UE is configured with the DRX and/or DTX parameters, the UE may have an active period and/or a non-active period. For example, for the DRX parameters, the active period may be a duration in which the UE receives downlink channels and/or signals (e.g., monitoring a PDCCH); the non-active period may be a duration in which the UE does not receive some or all downlink channels and/or signals. For the DTX parameters, the active period may be a duration in which the UE transmits uplink channels and/or signals; the non-active period may be a duration in which the UE does not transmit some or all uplink channels and/or signals, that is, the non-active period may be discontinuous reception and/or discontinuous transmission opportunities. Operations related to network power saving may be periodic. A power saving cycle may include an active period and/or a non-active period immediately following it. For example, when the UE is configured with the DRX parameters, a DRX cycle may include an active period and/or a non-active period immediately following it. The UE (e.g., the MAC entity, or the cell DRX and/or DTX) may receive physical downlink channels and/or downlink signaling and/or transmit physical uplink channels and/or uplink signaling according to at least one of manners MN1-MN15. The cell DRX and/or DTX may refer to cell-specific DRX and/or DTX. In some embodiments of the disclosure, the UE being configured with a mode (Mode 1 and/or Mode 2) related to network power saving and/or cell DRX and/or DTX may include that the UE is configured to have a corresponding mode or operate in a corresponding mode (UE power saving), and/or is notified that the base station or cell has a corresponding mode and/or the base station operates in a corresponding mode (network (base station) power saving).

### Manner MN1

In manner MN1, if the UE is configured with one or more parameters related to network power saving and/or cell DRX and/or DTX (for example, parameters related to one or more of the first mode or the second mode described above, or DRX and/or DTX parameters), the UE performs a DRX operation on predefined downlink channels and/or signals, that is, the UE discontinuously receives the predefined downlink channels and/or signals, and/or performs a DTX operation on a first uplink signal, and/or the UE performs a DTX operation on predefined uplink channels and/or signals, that is, the UE discontinuously transmits the predefined uplink channels and/or signals. When the base station and/or the UE (or the MAC entity, or the cell DRX and/or DTX) is in a power saving mode, or when the UE (or the MAC entity, or the cell DRX and/or DTX) is in a non-active period (or state) (for example, the UE (or the MAC entity, or the cell DRX and/or DTX) is in a non-active period), the behaviors of the UE may include at least one of:

the UE does not receive downlink channels and/or signals. In some examples, the UE does not receive all downlink channels and/or signals other than SSBs (synchronization signal (SS)/physical broadcast channel (PBCH) blocks). In other examples, the UE does not receive all downlink channels and/or signals. In still other examples, the UE does not receive predefined downlink channels and/or signals. For example, the UE does not receive the predefined downlink channels and/or signals of which all time domain resources (e.g., symbols) are in the non-active period. For another example, the UE does not receive the predefined downlink channels and/or signals of which time domain resources (e.g., symbols) overlap (e.g., completely overlap and/or partially overlap) with the non-active period. In still other examples, UE does not receive all downlink channels and/or signals other than SSBs and PDSCHs scheduled by DCI formats. In yet other examples, the UE does not receive all downlink channels and/or signals other than SSBs, symbols of a specific CORESET (for example, CORESET0; for another example, a CORESET associated with the Type0-PDCCH common search space (CSS) set; for yet another example, symbols indicated as pdcch-ConfigSIB1 by the MIB of the CORESET associated with the Type0-PDCCH CSS set) and PDSCHs scheduled by DCI formats. The predefined downlink channels and/or signals may be at least one of:
physical downlink channels and/or signals configured to be received by higher layer signaling
SPS PDSCHs
a PDSCH scheduled by a DCI format, where the PDSCH is configured or indicated to be transmitted with repetitions.
a PDSCH scheduled by a DCI format, where the DCI format schedules multiple PDSCHs. The multiple PDSCHs may be in a same serving cell and/or in different serving cells. For example, a PDSCH scheduled by a DCI format may be a PDSCH scheduled by a DCI format scrambled by SI-RNTI. For another example, a PDSCH scheduled by a DCI format may be a PDSCH scheduled by a DCI format scrambled by unicast RNTI (e.g., C-RNTI). For yet another example, a PDSCH scheduled by a DCI format may be a PDSCH scheduled by a DCI format scrambled by multicast RNTI (e.g., G-RNTI, G-CS-RNTI).
a PDCCH
a channel state information reference signal (CSI-RS)
a phase tracking reference signal (PT-RS)
a positioning reference signals (PRS) (the PRS may be a PRS with a higher priority and/or a PRS with a lower priority)
the UE does not transmit uplink channels and/or signals. In some examples, the UE does not transmit all uplink channels and/or signals. In other examples, the UE does not transmit predefined uplink channels. For example, the UE does not transmit the predefined uplink channels and/or signals of which all time domain resources (e.g., symbols) are in the non-active period. For another example, the UE does not transmit predefined uplink channels and/or signals of which time domain resources (e.g., symbols) overlap (e.g., completely overlap and/or partially overlap) with the non-active period. In still other examples, UE does not transmit all uplink channels and/or signals other than PUSCHs scheduled by DCI formats. In yet other examples, the UE does not transmit all uplink channels and/or signals other than PUSCHs scheduled by DCI formats and PRACHs. The predefined uplink channels may be at least one of:
physical uplink channels and/or signals configured to be received by higher layer signaling
CG PUSCHs. For example, the CG PUSCH may be a CG PUSCH that does not carry HARQ-ACK information (for example, HARQ-ACK information scheduled by a DCI format). If the CG PUSCH carries HARQ-ACK information, the UE transmits the CG PUSCH. This can improve the reliability of HARQ-ACK transmission, avoid the situation of not transmitting HARQ-ACK and reduce PDSCH or HARQ-ACK retransmissions, thus improving the spectrum efficiency of the system.
a PUSCH scheduled by a DCI format, where the PUSCH is configured or indicated to be transmitted with repetitions.
a PUSCH scheduled by a DCI format, where the DCI format schedules multiple PUSCHs. The multiple PUSCHs may be in a same serving cell and/or in different serving cells.
an SRS
a PUCCH with CSI
a PUCCH with HARQ-ACK, for example, a PUCCH with HARQ-ACK with a lower priority.
a PRACH
a PUCCH with SR
a message 3 (Msg3) PUSCH, for example, a PUSCH scheduled by a random access response (RAR).
a PUCCH with only SR and/or CSI. This can improve the reliability of HARQ-ACK transmission, avoid the situation of not transmitting HARQ-ACK and reduce PDSCH or HARQ-ACK retransmissions, thus improving the spectrum efficiency of the system.
a PUCCH with HARQ-ACK information only for SPS PDSCH receptions and/or SR and/or CSI. This can improve the reliability of HARQ-ACK transmission associated with dynamically scheduling, avoid the situation of not transmitting HARQ-ACK and reduce PDSCH or HARQ-ACK retransmissions, thus improving the spectrum efficiency of the system.
a PUCCH without HARQ-ACK information (e.g., HARQ-ACK information scheduled by a DCI format). This can improve the reliability of HARQ-ACK transmission, avoid the situation of not transmitting HARQ-ACK and reduce PDSCH or HARQ-ACK retransmissions, thus improving the spectrum efficiency of the system.

In some implementations, if the UE would transmit a PUCCH over

$${N}_{PUCCH}^{repeat}$$

slots and the UE does not transmit the PUCCH in a slot from the

$${N}_{PUCCH}^{repeat}$$

slots due to overlapping with non-active period of cell DRX in the slot (for example, the PUCCH overlaps with the non-active period of cell DRX), the UE counts the slot in the number of

$${N}_{PUCCH}^{repeat}$$

slots. In this manner, the UE does not defer the transmission of the PUCCH, and thus the transmission power of the UE and the power of the base station to detect the PUCCH can be reduced.

In some implementations, if the UE would transmit a PUCCH (e.g., a PUCCH with a lower priority, or a PUCCH of priority index 0) over

$${N}_{PUCCH}^{repeat}$$

slots and the UE does not transmit the PUCCH in a slot from the

$${N}_{PUCCH}^{repeat}$$

slots due to overlapping with a PUSCH transmission (e.g., a PUSCH transmission with a higher priority, or a PUSCH transmission of priority index 1) in the slot, the UE counts the slot in the number of

$${N}_{PUCCH}^{repeat}$$

slots. In this manner, the UE does not defer the transmission of the PUCCH, and thus the transmission power of the UE and the power of the base station to detect the PUCCH can be reduced.

In some implementations, if the UE would transmit a PUCCH over

$${N}_{PUCCH}^{repeat}$$

slots and the UE does not transmit the PUCCH in a slot from the

$${N}_{PUCCH}^{repeat}$$

slots due to LBT (listen before talk) failure in the slot, the UE counts the slot in the number of

$${N}_{PUCCH}^{repeat}$$

slots. In this manner, the UE does not defer the transmission of the PUCCH, and thus the transmission power of the UE and the power of the base station to detect the PUCCH can be reduced.

If the UE is configured with one or more parameters related to network power saving and/or cell DRX and/or DTX (e.g., cell DRX and/or DTX parameters), when the base station and/or the UE (or the MAC entity, or the cell DRX and/or DTX) is in non-power saving mode, or when the UE (or the MAC entity, or the cell DRX and/or DTX) is in an active period (or state) (for example, the UE (or the MAC entity, or the cell DRX and/or DTX) is in an active period), the behaviors of the UE include at least one of:
the UE receives downlink channels and/or signals. In some examples, the UE receives all downlink channels and/or signals. In other examples, the UE receives the predefined downlink channels and/or signals. For example, the UE receives the predefined downlink channels and/or signals of which all time domain resources (e.g., symbols) are in the active period. For another example, the UE receives the predefined downlink channels and/or signals of which time domain resources (e.g., symbols) overlap (e.g., completely overlap and/or partially overlap) with the active period. In still other examples, the UE receives downlink channels and/or signals (the predefined downlink channels and/or signals) of which at least part of time domain resources (e.g., symbols) are in the active period. For example, the UE receives the downlink channels and/or signals (the predefined downlink channels and/or signals) of which at least one symbol is in the active period. For another example, the UE receives the downlink channels and/or signals (the predefined downlink channels and/or signals) of which a starting symbol (or position) is in the active period. For yet another example, the UE receives the downlink channels and/or signals (the predefined downlink channels and/or signals) of which an end symbol (or position) is in the active period.
the UE transmits uplink channels and/or signals. In some examples, the UE transmits all uplink channels and/or signals. In other examples, the UE transmits the predefined uplink channels. For example, the UE transmits the predefined uplink channels and/or signals of which all time domain resources (e.g., symbols) are in the active period. For another example, the UE transmits the predefined uplink channels and/or signals of which time domain resources (e.g., symbols) overlap (e.g., completely overlap and/or partially overlap) with the active period. In still other examples, the UE transmits uplink channels and/or signals (the predefined uplink channels and/or signals) of which at least part of time domain resources (e.g., symbols) are in the active period. For example, the UE transmits the uplink channels and/or signals (the predefined uplink channels and/or signals) of which at least one symbol is in the active period. For another example, the UE transmits the uplink channels and/or signals (the predefined uplink channels and/or signals) of which a starting symbol (or position) is in the active period. For yet another example, the UE transmits the uplink channels and/or signals (the predefined uplink channels and/or signals) of which an end symbol (or position) is in the active period.

In embodiments of the disclosure, “a physical channel and/or a physical signal overlapping with an active period” may include that: at least one of the starting time or the end time of the physical channel and/or the physical signal is in the active period; both the starting time and the end time of the physical channel and/or the physical signal are in the active period; at least one symbol of the physical channel and/or the physical signal is in the active period; or all symbols of the physical channel and/or the physical signal are in the active period.

In embodiments of the disclosure, “a physical channel and/or a physical signal overlapping with a non-active period (for example, discontinuous reception and/or discontinuous transmission opportunity)” may include that: at least one of a starting time or an end time of the physical channel and/or the physical signal is in the non-active period; both the starting time and end time of the physical channel and/or the physical signal is in the non-active period; at least one symbol of the physical channel and/or the physical signal is in the non-active period; or all symbols of the physical channel and/or the physical signal are in the non-active period.

In some implementations, it may be specified by protocols that for a serving cell, the UE does not expect that a physical channel or signal scheduled (or indicated) by a DCI format overlaps with the non-active period. For example, the physical channel or signal may be a physical downlink channel or signal, and the non-active period may be a downlink non-active period. The physical downlink channel may be a PDSCH. The physical downlink signal may be a CSI-RS. For example, the PDSCH may be a PDSCH that is not configured or indicated to be transmitted with repetitions; and/or the DCI format only schedules one PDSCH on one serving cell.

In some implementations, it may be specified by protocols that for a serving cell, the UE does not expect that all physical channels or signals scheduled (or indicated) by a DCI format each overlap with the non-active period. For example, the physical channel or signal may be a physical downlink channel or signal, and the non-active period may be a downlink non-active period. The physical downlink channel may be a PDSCH. The physical downlink signal may be a CSI-RS. For example, the PDSCH may be a PDSCH that is not configured or indicated to be transmitted with repetitions; and/or the DCI format may schedule one or more PDSCHs on one serving cell. The all physical channels may be all repetitions of a PDSCH transmission.

In some implementations, it may be specified by protocols and/or configured by higher layer signaling that the UE receives or transmits a physical channel or signal scheduled by a DCI format. For example, the physical channel or signal may be a physical downlink channel or signal. The physical downlink channel may be PDSCH. For example, the PDSCH may be a PDSCH that is not configured or indicated to be transmitted with repetitions; and/or the DCI format only schedules one PDSCH. For example, the PDSCH may overlap with the non-active period.

In some implementations, it may be specified by protocols and/or configured by higher layer signaling that for a serving cell, the UE receives or transmits a physical channel or signal scheduled by a DCI format. For example, the physical channel or signal may be a physical downlink channel or signal. The physical downlink channel may be a PDSCH. The PDSCH may be a PDSCH that is not configured or indicated to be transmitted with repetitions; and/or for a serving cell, the DCI format only schedules one PDSCH. For example, for the serving cell, the PDSCH may overlap with the non-active period.

It should be noted that the above method can also be applied to uplink, for example, by replacing the ‘physical downlink channel’ with ‘physical uplink channel’, replacing the ‘downlink non-active period’ with ‘uplink non-active period’, replacing the ‘PDSCH’ with ‘PUSCH’ (or PUCCH), and replacing the ‘CSI-RS’ with ‘SRS’. The PUCCH may be a PUCCH configured with repetitions.

The method clarifies whether the UE transmits or receives a physical channel when the physical channel overlap with the network power-saving state, and the behaviors of the UE, and can reduce the reception of signals by the UE that are not transmitted by the base station and the transmission of signals by the UE that are not received by the base station, thereby reducing the power consumption of the UE. In addition, reference signals that would not transmitted by the base station, such as CSI-RSs, are not received, and uplink signals that would not be received by the base station are not transmitted. For example, the transmission of a SR can be deferred until the active period, and thus the reliability of communication can be improved.

### Manner MN2

In manner MN2, the UE may determine a physical downlink channel and/or signaling to be received by the UE and/or a physical uplink channel and/or signaling to be transmitted by the UE according to the following steps.
The UE first determines overlapping for PUCCH and/or PUSCH transmissions. For example, the PUCCHs may be PUCCHs other than PUCCHs with SL HARQ-ACK reports. When the UE determines the overlapping for the PUCCH and/or PUSCH transmissions, the UE resolves the overlapping among the PUCCH and/or PUSCH transmissions.
The UE then determines the physical downlink channel and/or signaling to be received by the UE and/or the physical uplink channel and/or signaling to be transmitted by the UE according to uplink and downlink frame structure information configured by higher layer signaling (for example, 3GPP parameters tdd-UL-DL-ConfigurationCommon and/or tdd-UL-DL-ConfigurationDedicated) and/or indicated by dynamic signaling (for example, a dynamic slot format indicator (SFI), information of which is carried by a DCI format 2_0) and a cancellation indication (for example, the indication of a DCI format 2_4).
The UE receives the physical downlink channel and/or signaling and/or transmits the physical uplink channel and/or signaling according to the method of manner MN1.

It should be noted that the above second step and third step can be combined.

The method is simple to implement and can reduce the implementation complexity of the UE and the base station.

### Manner MN3

In manner MN3, the UE may determine a physical downlink channel and/or signaling to be received by the UE and/or a physical uplink channel and/or signaling to be transmitted by the UE according to the following steps.
The UE determines physical downlink channels and/or signaling to be received and/or physical uplink channels and/or signaling to be transmitted according to the method of manner MN1.
The UE determines overlapping for PUCCH and/or PUSCH transmissions. For example, the PUCCHs may be PUCCHs other than PUCCHs with SL HARQ-ACK reports. When the UE determines the overlapping for the PUCCH and/or PUSCH transmissions, the UE resolves the overlapping among the PUCCH and/or PUSCH transmissions.
The UE then determines a physical downlink channel and/or signaling to be received by the UE and/or a physical uplink channel and/or signaling to be transmitted by the UE according to uplink and downlink frame structure information configured by higher layer signaling (for example, 3GPP parameters tdd-UL-DL-ConfigurationCommon and/or tdd-UL-DL-ConfigurationDedicated) and/or indicated by dynamic signaling (for example, a dynamic SFI, information of which is carried by a DCI format 2_0) and a cancellation indication (for example, the indication of a DCI format 2_4).

In an example, considering the situation as shown in FIG. 10A, where a PUCCH on a serving cell CC1 overlaps with a PUSCH on a serving cell CC2 in time domain, the PUSCH on the serving cell CC2 is in the non-active period, the PUCCH on the serving cell CC1 is in the active period, and the PUCCH does not overlap with downlink symbols of the serving cell. According to the method, the UE may first determine that the PUSCH is not transmitted, the UE does not multiplex the PUCCH in the PUSCH, and the UE may transmit the PUCCH. The method can increase the chance of the physical channel or UCI information transmission, thus reducing network delay and improving network spectrum efficiency.

### Manner MN4

In manner MN4, the UE may determine a physical downlink channel and/or signaling to be received by the UE and/or a physical uplink channel and/or signaling to be transmitted by the UE according to the following steps.
The UE determines PUSCHs and/or PUCCHs (e.g., PUCCH with repetitions) to be transmitted according to the method of manner MN1.
The UE first determines overlapping for PUCCH and/or PUSCH transmissions. For example, the PUCCHs may be PUCCHs other than PUCCHs with SL HARQ-ACK reports.
The UE then determines physical downlink channels and/or signaling to be received by the UE and/or physical uplink channels and/or signaling to be transmitted by the UE according to uplink and downlink frame structure information configured by higher layer signaling (for example, 3GPP parameters tdd-UL-DL-ConfigurationCommon and/or tdd-UL-DL-ConfigurationDedicated) and/or indicated by dynamic signaling (for example, a dynamic SFI, information of which is carried by a DCI format 2_0) and a cancellation indication (for example, the indication of a DCI format 2_4).
The UE receives a physical downlink channel and/or signaling and/or transmits a physical uplink channel and/or signaling according to the method of manner MN1.

It should be noted that the above third step and fourth step can be combined.

In an example, considering the situation shown in FIG. 10B, where a PUCCH on a serving cell CC3 overlaps with PUSCHs on serving cells CC1 and CC2 in time domain, the PUSCH on the serving cell CC1 is in the non-active period, the PUSCH on the serving cell CC2 is in the non-active period, the PUSCH on the serving cell CC3 is in the non-active period, and the PUSCH on the serving cell CC2 does not overlap with downlink symbols of the serving cell. According to the first step of the method, the UE determines that the PUSCH on the serving cell CC1 is not transmitted; according to the second step, the UE multiplexes the PUCCH in the PUSCH on the serving cell CC2; and according to the third step, the UE may transmit the PUSCH on the serving cell CC2. The method can increase the chance of physical channel or UCI information transmission, thus reducing network delay and improving network spectrum efficiency.

### Manner MN5

In manner MN5, for a serving cell, when a physical channel or signal scheduled by a DCI format is in a power saving mode (for example, in discontinuous reception and/or discontinuous transmission opportunity) or when a physical channel or signal scheduled (or indicated) by a DCI format (for example, the physical channel or signal described according to the embodiments of manner MN1) overlaps with the non-active period (for example, discontinuous reception and/or discontinuous transmission opportunity), if the end position (or end symbol) of the PDCCH carrying the DCI format is earlier than a first time point T1 time (or N1 symbols), the UE receives or transmits the physical channel or signal, otherwise, the UE does not receive or transmit the physical channel or signal. T1 and N1 may be nonnegative rational numbers. T1 and N1 may be predefined, or may be configured by the base station or based on capabilities reported by the UE. For example, the DCI format only schedules one PDSCH, where the PDSCH is not configured or indicated to be transmitted with repetitions.

For example, “a physical channel and/or physical signal overlapping with a non-active period (for example, discontinuous reception and/or discontinuous transmission opportunity)” may include that: at least one of the starting time or end time of the physical channel and/or the physical signal is in the non-active period; both the starting time and end time of the physical channels and/or the physical signals are in the non-active period; at least one symbol of the physical channels and/or the physical signals is in the non-active period; or all symbols of the physical channels and/or the physical signals are in the non-active period.

In some implementations, the first time point may be at least one of:
the starting symbol or starting time (or position) of the physical channel or signal.
the earliest time (or symbol) when the physical channel or signal overlaps with the non-active period.

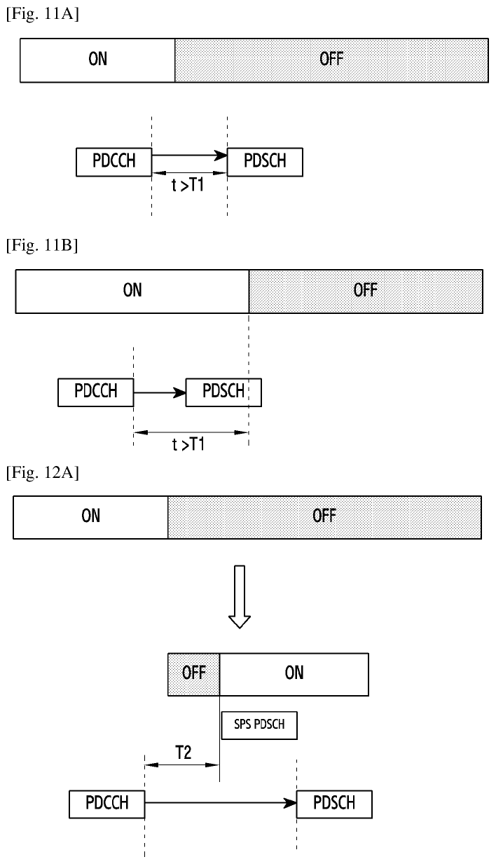

FIGS. 11A and 11B illustrate examples of a timeline for dynamic indication according to some embodiments of the disclosure, respectively. In FIGS. 11A and 11B, ‘ON’ may indicate an active period and ‘OFF’ may indicate a non-active period. In some examples, when the end position (or end symbol) of the PDCCH is earlier than the first time point T1, the UE may receive the PDSCH, where the first time point is the starting symbol or starting time (or position) of the PDSCH, as shown in FIG. 11A. In some examples, when the end position (or end symbol) of the PDSCH is earlier than the first time point T1, the UE may receive the PDSCH, where the first time point T1 is the earliest time (or earliest symbol) in which the PDSCH overlaps with the non-active period, as shown in FIG. 11B.

In some implementations, it may be specified by protocols that for a serving cell, the UE does not expect to receive a PDCCH within T1 time (or N1 symbols) prior to the non-active period, where the PDCCH schedules a physical channel or signal overlapping with the non-active period. For example, the DCI format only schedules one PDSCH, where the PDSCH is not configured or indicated to be transmitted with repetitions. For another example, the DCI format only schedules one PDSCH, where the PDSCH is configured or indicated to be transmitted with repetitions, and the physical channel is all the repetitions of the PDSCH. For yet another example, the DCI format only schedules multiple PDSCHs, and the physical channel is all the PDSCH scheduled by the DCI format. Or, for a serving cell, the UE does not monitor a PDCCH within T1 time (or N1 symbols) prior to the non-active period.

The method can prevent the UE from buffering downlink data during the non-active period, and can reduce the power consumption of the UE.

### Manner MN6

In manner MN6, for a serving cell, if the UE receives a PDCCH carrying a DCI format, for example, a DCI format for scheduling a PDSCH or a PUSCH (for example, the DCI format only schedules one PDSCH or PUSCH, and/or the PDSCH or PUSCH is not configured or indicated to be transmitted with repetitions), the active period may include a time from a first reference time to a second reference time, where the first reference time is one of: a time after T2 time (or N2 symbols) after the end time of the PDCCH, or the starting time (for example, the first symbol) of the PDSCH or the PUSCH, and the second reference time is the end time (for example, the first symbol) of the PDSCH or the PUSCH. For example, the active period is a time period from a time that is T2 time (N2 symbols) after the end time (or position) of the PDCCH to the end time (or position) of the PDSCH or PUSCH. That is, the starting time when the non-active period is converted into the active period is T2 time (or N2 symbols) after the end time (or position) of the PDCCH, and the end time when the non-active period is converted into the active period is the end time (or position) of the PDSCH or PUSCH. Or, the duration of the PDSCH (or PUSCH) (that is, the occupied time or symbols) is the active period. T1 and N1 may be predefined, or may be configured by the base station or based on capabilities reported by the UE.

FIGS. 12A and 12B illustrate examples of the active period according to some embodiments of the disclosure, respectively. Referring to FIG. 12A, a PDSCH is scheduled by a PDCCH, and the active period is from a time that is T2 time after the end time (or position) of the PDCCH to the end time (or position) of the PDSCH. Referring to FIG. 12B, a PDSCH is scheduled by a PDCCH, and the active period is the duration of the PDSCH (that is, the occupied time or symbols).

It should be noted that the above method is also applicable to a DCI format indicating a PUCCH with HARQ-ACK.

The method defines a method for dynamic conversion from the non-active period to the active period, which can improve the flexibility of scheduling.

### Manner MN7

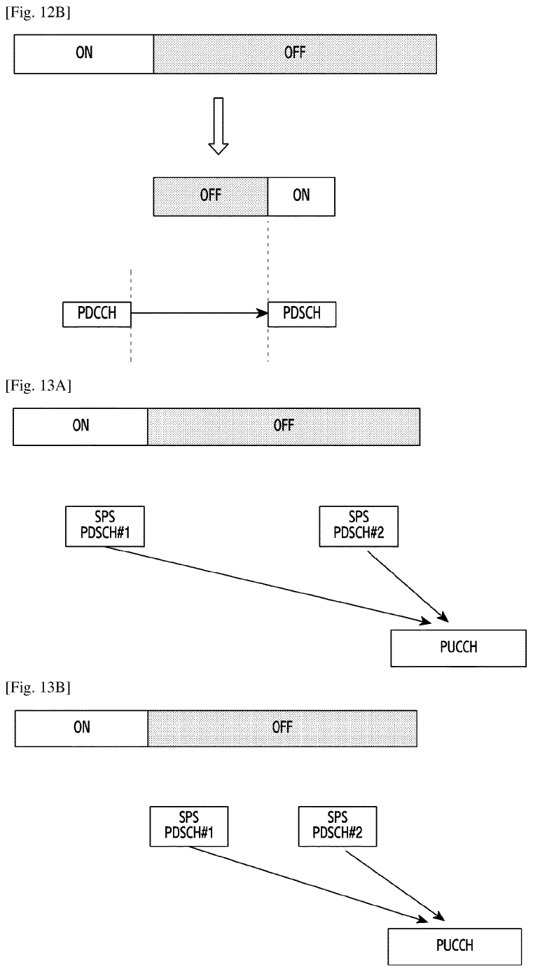

In manner MN7, the UE may be configured to receive one or more SPS PDSCHs for which HARQ-ACK is transmitted in a same slot, for example, in slot n. As an example, the UE may be configured to receive SPS PDSCH #1 and SPS PDSCH #2, where SPS PDSCH #2 is in the active period (as indicated by ‘ON’) and SPS PDSCH #2 is in the non-active period (as indicated by ‘OFF’), as shown in FIG. 13A. For another example, the UE may be configured to receive SPS PDSCH #1 and SPS PDSCH #2, where both SPS PDSCH #1 and SPS PDSCH #2 are in the non-active period, as shown in FIG. 13B. If the UE receives at least one of the one or more SPS PDSCHs according to the method of other embodiments of the disclosure (for example, during the active period), the UE generates HARQ-ACK information for the one or more SPS PDSCHs. For example, a HARQ-ACK codebook transmitted in slot n contains all the HARQ-ACK information for the one or more SPS PDSCHs. If the UE does not receive any SPS PDSCH according to the method of other embodiments of the disclosure, the UE does not generate HARQ-ACK information for SPS PDSCHs. The UE does not transmit HARQ-ACK information. Continuing to refer to FIG. 13A, according to the method of other embodiments of the disclosure, the UE receives SPS PDSCH #1, but does not receive SPS PDSCH #2. In this case, the UE may generate HARQ-ACK information for SPS PDSCH #1 and SPS PDSCH #2. The HARQ-ACK codebook transmitted in slot n through a PUCCH may contain, for example, HARQ-ACK information for SPS PDSCH #1 and SPS PDSCH #2. Continuing to refer to FIG. 13B, if UE does not receive SPS PDSCH #1 and SPS PDSCH #2 according to the method of other embodiments of the disclosure, the UE may not generate HARQ-ACK information for SPS PDSCH #1 and SPS PDSCH #2. For example, the UE may not transmit HARQ-ACK information.

It should be noted that the method may be applied to the scene where HARQ-ACK information for a PDSCH scheduled by a DCI is not included in slot n. If HARQ-ACK for a PDSCH scheduled by a DCI is included in slot n, the UE transmits the HARQ-ACK codebook in slot n. The HARQ-ACK codebook contains all the HARQ-ACK information for the one or more SPS PDSCHs.

The method can ensure the consistency of the understanding of the HARQ-ACK codebook between the UE and the base station, and can improve the reliability of uplink transmission.

### Manner MN8

In manner MN8, the “HARQ-ACK codebook contains all the HARQ-ACK information for the one or more SPS PDSCHs” in manner MN7 may be replaced by “HARQ-ACK codebook contains only HARQ-ACK information for SPS PDSCHs received according to the method of other embodiments of the disclosure”. Continuing to refer to FIG. 13A, according to the embodiments of manner MN8, if the UE receives SPS PDSCH #1 and the UE does not receive SPS PDSCH #2 according to the method of other embodiments of the disclosure, the HARQ-ACK codebook transmitted by the UE in slot n may only contain the HARQ-ACK information for SPS PDSCH #1. This can reduce a number of HARQ-ACK bits, reduce resources occupied by the PUCCH, and improve the spectrum efficiency.

It should be noted that in the method, the SPS PDSCH reception of MN7-MN 8 can be a SPS PDSCH reception determined according to a configuration by higher layer signaling. For example, when the UE is not configured to receive information indicating power saving, the UE can determine the HARQ-ACK information of SPS PDSCH by the method. This can improve the reliability of downlink reception and avoid the inconsistency of understanding between the base station and the UE in case of miss detection of the DCI.

### Manner MN9

In manner MN9, the UE determines a HARQ-ACK codebook based on a SPS PDSCH being configured to receive. That is, when the SPS PDSCH is configured to receive, if DRX is configured, the UE generates HARQ-ACK information for the SPS PDSCH regardless of whether the SPS PDSCH is received by the UE (for example, according to the method of other embodiments of the disclosure).

The method can reduce the implementation complexity.

It should be noted that the method when cell DRX or DTX is configured according to the embodiment of the disclosure is also applicable to DRX reception (for example, DRX reception for UE power saving). This can reduce the power consumption of the UE.

### Manner MN10

In manner MN10, if the cell DRX and/or DTX is configured, the active period may include at least one of:
symbol(s) where a SSB transmission is located.
symbol(s) where a valid RACH occasion (RO) is located.
symbol(s) where a RO (for example, a valid RO) associated with a SSB and/or CSI-RS is located.
symbol(s) where a PDSCH reception scheduled by a DCI format is located, for example, symbol(s) where the PDSCH reception not overlapping with uplink symbols configured by higher layer signaling is located.
symbol(s) where a PUSCH transmission scheduled by a DCI format is located, for example, symbol(s) where the PUSCH transmission not overlapping with downlink symbols configured by higher layer signaling is located.
symbol(s) where a CSI report triggered by a DCI format is located.
symbol(s) where a CSI-RS reception corresponding to a CSI report triggered by a DCI format is located.
symbol(s) where an SRS transmission triggered by a DCI format is located.
symbol(s) where a PUCCH (for example, a PUCCH with HARQ-ACK)

transmission indicated by a DCI format is located, for example, symbol(s) where the PUCCH transmission transmitted by the UE is located.
a Msg3 (message 3) PUSCH, for example, symbol(s) where a PUSCH transmission scheduled by a RAR (random access response) is located.
symbol(s) where a PUCCH transmission with HARQ-ACK for a message 4 (Msg4) PDSCH is located.

The method can be enabled by a configuration via higher layer signaling. For example, if the UE is configured with a higher layer parameter (for example, a parameter for implicitly determining the active period), the manner MN10 is enabled. Or, whether the manner MN10 is enabled or not can be dynamically indicated in a DCI format. For example, it is indicated by 1 bit, where “1” means enabled, and “0” means not enabled.

The method can reduce the dynamic signaling that dynamically indicates the DRX and/or DTX active period of the cell, and can save the signaling overhead, thereby reducing the energy consumption of the base station and achieving the purpose of network power saving.

### Manner MN11

In manner MN11, if the cell DRX and/or DTX is configured, the active period may include at least one of:
time unit(s) (for example, the time unit may be a slot, a subslot or a symbol) where a SSB transmission is located.
time unit(s) (for example, the time unit may be a slot, a subslot or a symbol) where

a valid RO is located.
time unit(s) (for example, the time unit may be a slot, a subslot or a symbol) where a RO (for example, a valid RO) associated with a SSB and/or a CSI-RS is located.
time unit(s) (for example, the time unit may be a slot, a subslot or a symbol) where a PDSCH reception scheduled by a DCI format is located, for example, time unit(s) (for example, the time unit may be a slot, a subslot or a symbol) where a PDSCH reception not overlapping with uplink time units (for example, the time unit may be a slot, a subslot or a symbol) configured by higher layer signaling is located.
time unit(s) (for example, the time unit may be a slot, a subslot or a symbol) where a PUSCH transmission scheduled by a DCI format is located, for example, a time unit (for example, the time unit may be a slot, a subslot or a symbol) where a PUSCH transmission not overlapping with downlink time units (for example, the time unit may be a slot, a subslot or a symbol) configured by higher layer signaling is located.
time unit(s) (for example, the time unit may be a slot, a subslot or a symbol) where a CSI report triggered by a DCI format is located.
time unit(s) (for example, the time unit may be a slot, a subslot or a symbol) where a CSI-RS reception corresponding to a CSI report triggered by a DCI format is located.
time unit(s) (for example, the time unit may be a slot, a subslot or a symbol) where an SRS transmission triggered by a DCI format is located.
time unit(s) (for example, the time unit may be a slot, a subslot or a symbol) where a PUCCH (for example, a PUCCH with HARQ-ACK) transmission indicated by a DCI format is located, for example, a time unit (for example, the time unit may be a slot, a subslot or a symbol) where a PUCCH transmission transmitted by the UE is located.
a Msg3 PUSCH, for example, time unit(s) (for example, the time unit may be a slot, a subslot or a symbol) where a PUSCH transmission scheduled by a RAR is located.
time unit(s) (for example, the time unit may be a slot, a subslot or a symbol) where a PUCCH transmission carrying HARQ-ACK corresponding to a Msg4 PDSCH is located.

The method may be enabled by a configuration via higher layer signaling. For example, if the UE is configured with a higher layer parameter (for example, a parameter for implicitly determining the active period), the manner MN11 is enabled. Or, whether the manner MN11 is enabled or not can be dynamically indicated in a DCI format. For example, it is indicated by 1 bit, where “1” means enabled, and “0” means not enabled.

The method can reduce the dynamic signaling that dynamically indicates the DRX and/or DTX active period of the cell, and can save the signaling overhead, thereby reducing the energy consumption of the base station and achieving the purpose of network power saving.

The method for resolving conflict or overlapping among uplink channels or signals in the exemplary embodiments of the disclosure can also be used for downlink channels, and downlink channels or signals to be received can also be determined by at least one of manners MN12-MN15.

### Manner MN12

The UE may determine a physical downlink channel to be received by the UE according to the following steps.
The UE determines physical downlink channels (e.g., SPS PDSCH) to be received by the UE according to higher layer signaling (for example, 3GPP parameters tdd-UL-DL-ConfigurationCommon and/or tdd-UL-DL-ConfigurationDedicated) configuration.
The UE determines physical downlink channels to be received according to the method of manner MN1.
The UE determines overlapping for PDSCH receptions (resolves the overlapping among the PDSCH receptions). For example, it is determined according to at least one of manners MN13-MN14.

It should be noted that the first two steps can be combined into one step, that is, the UE determines physical downlink channels to be received according to the higher layer signaling configuration and the method of manner MN1, and then the UE determines the overlapping among PDSCH reception (resolving the overlapping PDSCH reception).

The method can increase the chance of downlink transmission and reduce the scheduling delay.

### Manner MN13

In manner MN13, consider the case where the UE does not receive a SPS PDSCH on a serving cell, for example, a SPS PDSCH in a non-active period, according to the method defined in manner MN1. If the UE receives a PDCCH scheduling a PDSCH on the serving cell that partially or completely overlaps in time with the SPS PDSCH, the PDCCH and the SPS PDSCH are not required to satisfy a timing condition. That is, only when the SPS PDSCH is not in the non-active period (when the UE is required to receive the SPS PDSCH), the PDCCH and the PDSCH need to satisfy the timing condition. For example, the timing condition may be that the scheduling PDCCH is at least X symbols earlier than the starting symbol of the SPS PDCCH. X is a predefined number of symbols. For example, X=14·2^{max(0,μ-3)}. μ and the symbol duration are determined based on a numerology with the minimum value between the scheduling PDCCH and the PDSCH.

In an example, a UE does not expect to decode PDSCH in a serving cell scheduled by a PDCCH with C-RNTI, CS-RNTI, MCS-C-RNTI, G-RNTI, G-CS-RNTI or MCCH-RNTI, and to be configured to receive one or more PDSCHs (e.g., SPS PDSCHs) without a corresponding PDCCH transmission in a same serving cell. If PDSCHs partially or completely overlaps in time (for example, a PDSCH scheduled by a PDCCH overlaps with a SPS PDSCH in time), the UE shall decode the PDSCH scheduled by the PDCCH in this case, unless the PDCCH scheduling the PDSCH ends at least X symbols earlier than the earliest starting symbol of a PDSCH without a corresponding PDCCH transmission. X is a predefined number of symbols. For example, X=14·2^{max(0,μ-3)}. μ and the symbol duration are determined based on a numerology with the minimum value between the scheduling PDCCH and the PDSCH.

It should be noted that the method is also applicable to reception of a DCI format indicating SPS PDSCH release. In an example, if the UE is required to receive a SPS PDSCH in a slot and the SPS PDSCH configuration is indicated to be released by a DCI format, if the end of the last symbol of the PDCCH reception (e.g., the PDCCH carrying the DCI format) is after the end of the last symbol of any SPS PDSCH reception, the UE does not expect to receive the DCI format in the slot, unless the SPS PDSCH is in the non-active period (or the UE determines not to receive the SPS PDSCH according to manner 1).

This can improve the flexibility of scheduling and reduce the scheduling delay.

### Manner MN14

In manner MN14, if more than one PDSCH on a serving cell each without a corresponding PDCCH transmission is in a slot on a serving cell, after resolving overlapping with symbols in the slot indicated as uplink by higher layer signaling (e.g., tdd UL DL ConfigurationCommon or tdd UL-DL ConfigurationDedicated) and determining PDSCHs to be received (for example, determining based on the method of manner MN1) according to the non-active period (or state) (for example, the non-active period (or state) defined in manner MN1), then the UE receives one or more PDSCHs without corresponding PDCCH transmissions in the slot as specified below.
Step 0: set j=0, where j is the number of selected PDSCH(s) for decoding. Q is the set of activated PDSCHs without corresponding PDCCH transmissions in the slot.
Step 1: the UE receives one PDSCH with the lowest configured SPS configuration index (for example, sps-ConfigIndex) within Q, set j=j+1. Designate the received PDSCH as a survivor PDSCH.
Step 2: the survivor PDSCH in step 1 and any other PDSCH(s) overlapping (even partially) with the survivor PDSCH in step 1 are excluded from Q.
Step 3: repeat steps 1 and 2 until Q is empty or j is equal to the number of unicast/multicast PDSCHs in a slot supported by the UE.

The method can increase the chance of SPS PDSCH transmission. For example, when SPS PDSCH #2 and SPS PDSCH #1 overlap in time domain, if SPS PDSCH #1 is in the non-active period, the UE can receive SPS PDSCH #2. This can improve the downlink transmission efficiency and reduce the delay.

It should be noted that in the method, the active period of MN12-MN14 can be an active period determined according to a configuration via higher layer signaling. For SPS PDSCH, whether to receive the SPS PDSCH can be further determined according to the active period determined by an indication of a DCI format. This can improve the reliability of downlink reception and avoid the inconsistency of understanding between the base station and the UE in case of miss detection of the DCI.

### Manner MN15

In manner MN15, the UE may determine a physical downlink channel to be received by the UE according to the following steps.
If more than one PDSCH on a serving cell each without a corresponding PDCCH transmission is in a slot on a serving cell, after resolving overlapping with symbols in the slot indicated as uplink by higher layer signaling (e.g., tdd UL DL ConfigurationCommon or tdd UL-DL ConfigurationDedicated), then the UE receives one or more PDSCHs without corresponding PDCCH transmissions in the slot as specified below.
Step 0: set j=0, where j is the number of selected PDSCH(s) for decoding. Q is the set of activated PDSCHs without corresponding PDCCH transmissions within the slot.
Step 1: the UE receives one PDSCH with the lowest configured SPS configuration index (for example, sps-ConfigIndex) within Q, and set j=j+1. Designate the received PDSCH as a survivor PDSCH.
Step 2: the survivor PDSCH in step 1 and any other PDSCH(s) overlapping (even partially) with the survivor PDSCH in step 1 are excluded from Q.
Step 3: repeat steps 1 and 2 until Q is empty or j is equal to the number of unicast/multicast PDSCHs in a slot supported by the UE.
The UE determines a physical downlink channel to be received according to the method of manner MN1.

The method can reduce the implementation complexity of the UE and the base station.

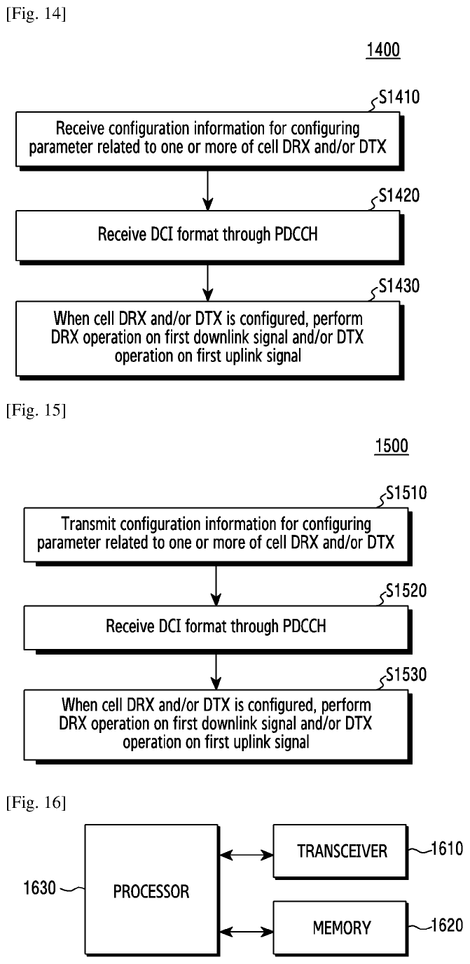

FIG. 14 illustrates a flowchart of a method 1400 performed by a terminal according to some embodiments of the disclosure.

Referring to FIG. 14, in operation S1410, the terminal receives configuration information for configuring a parameter related to one or more of cell DRX and/or DTX. For example, the configuration information may be received from a base station through higher layer signaling (e.g., an RRC message).

Continuing to refer to FIG. 14, in operation S1420, the terminal receives a DCI format through a PDCCH. For example, the terminal may receive the DCI format from the base station through the PDCCH.

Next, in operation S1430, when the cell DRX and/or DTX is configured, the terminal performs a DRX operation on a first downlink signal and/or a DTX operation on a first uplink signal. The DRX operation includes receiving the first downlink signal in a first time, and the DTX operation includes transmitting the first uplink signal in the first time. The first time is determined based on the configuration information and the DCI format.

In some implementations, operations S1410 and/or S1420 and/or S1430 may be performed based on the methods described according to various embodiments (e.g., various manners described above, such as manners MN1-MN7) of the disclosure.

In some implementations, the method 1400 may omit one or more of operations S1410 to S1430, or may include additional operations, for example, the operations performed by the terminal (e.g., a UE) that are described according to various embodiments (e.g., various manners described above, such as manners MN1-MN15) of the disclosure.

FIG. 15 illustrates a flowchart of a method 1500 performed by a base station according to some embodiments of the disclosure.

Referring to FIG. 15, in operation S1510, the base station transmits configuration information for configuring a parameter related to one or more of cell DRX and/or DTX to a terminal. For example, the configuration information may be transmitted to the terminal through higher layer signaling (e.g., an RRC message).

Continuing to refer to FIG. 15, in operation S1520, the base station transmits a DCI format to the terminal through a PDCCH.

Next, in operation S1530, when the cell DRX and/or DTX is configured for the terminal, the base station performs a DTX operation on a first downlink signal and/or a DRX operation on a first uplink signal. The DTX operation includes transmitting the first downlink signal in a first time, and the DRX operation includes receiving the first uplink signal in the first time. The first time is determined based on the configuration information and the DCI format.

In some implementations, operations S1510 and/or S1520 and/or S1530 may be performed based on the methods described according to various embodiments (e.g., various manners described above, such as manners MN1-MN7) of the disclosure.

In some implementations, the method 1500 may omit one or more of operations S1510 to S1530, or may include additional operations, for example, the operations performed by the base station that are described according to various embodiments (e.g., various manners described above, such as manners MN1-MN15) of the disclosure.

In an embodiment of the present disclosure, a method performed by a terminal in a wireless communication system, comprising: receiving configuration information for configuring a parameter related to one or more of cell discontinuous reception (DRX) and/or discontinuous transmission (DTX); receiving a downlink control information (DCI) format through a physical downlink control channel (PDCCH); and when the cell DRX and/or DTX is configured, performing a DRX operation on a first downlink signal and/or performing a DTX operation on a first uplink signal, wherein the DRX operation includes receiving the first downlink signal in a first time, and the DTX operation includes transmitting the first uplink signal in the first time, wherein the first time is determined based on the configuration information and the DCI format.

In an embodiment of the present disclosure, wherein the DCI format includes a first DCI format that schedules or indicates reception of a second downlink signal, and the first time includes a time from a first reference time to a second reference time, wherein, the first reference time is one of a time after a second time after an end time of the PDCCH, or a starting time of the second downlink signal, and the second reference time is an end time of the second downlink signal.

In an embodiment of the present disclosure, wherein the second time is configured by a base station or based on a capability reported by the terminal.

In an embodiment of the present disclosure, wherein the DCI format includes a first DCI format that schedules or indicates reception of a second downlink signal, wherein the first time is determined to include a time from a first symbol of the second downlink signal to a last symbol of the second downlink signal.

In an embodiment of the present disclosure, wherein the second downlink signal includes one or more of: a PDSCH that is not configured or indicated to be transmitted with repetitions; a PDSCH scheduled by the first DCI format; or a PDSCH scheduled by the first DCI format, wherein the first DCI format does not schedule multiple PDSCHs.

In an embodiment of the present disclosure, wherein the DCI format includes a second DCI format that schedules or indicates transmission of a second uplink signal, and the first time includes a time from a third reference time to a fourth reference time, wherein, the third reference time is one of a time after a third time after an end time of the PDCCH, or a starting time of the second uplink signal, and the fourth reference time is an end time of the second uplink signal.

In an embodiment of the present disclosure, wherein the third time is configured by a base station or based on a capability reported by the terminal.

In an embodiment of the present disclosure, wherein the DCI format includes a second DCI format that schedules or indicates transmission of a second uplink signal, wherein the first time is a time from a first symbol of the second uplink signal to a last symbol of the second uplink signal.

In an embodiment of the present disclosure, wherein the second uplink signal includes one or more of: a PUSCH that is not configured or indicated to be transmitted with repetitions; a PUSCH scheduled by the first DCI format; or a PUSCH scheduled by the first DCI format, wherein the first DCI format does not schedule multiple PUSCHs.

In an embodiment of the present disclosure, wherein the first downlink signal includes one or more of: a physical downlink channel and/or a physical downlink signal satisfying a first predefined condition; a physical downlink channel and/or a physical downlink signal configured to be received by higher layer signaling; a semi-persistent scheduling (SPS) physical downlink shared channel (PDSCH); a PDSCH scheduled by a DCI format, wherein the PDSCH is configured or indicated to be transmitted with repetitions; a PDSCH scheduled by a DCI format, wherein the DCI format schedules multiple PDSCHs; a physical downlink control channel (PDCCH); a channel state information reference signal (CSI-RS); a phase tracking reference signal (PT-RS); or a positioning reference signal (PRS).

In an embodiment of the present disclosure, wherein, for the physical downlink channel and/or the physical downlink signal, the first predefined condition includes one or more of: at least one of a starting time or an end time of the physical downlink channel and/or the physical downlink signal being within the first time; the starting time and the end time of the physical downlink channel and/or the physical downlink signal being within the first time; at least one symbol of the physical downlink channel and/or the physical downlink signal being within the first time; or all symbols of the physical downlink channel and/or the physical downlink signal being within the first time.

In an embodiment of the present disclosure, wherein the first uplink signal includes one or more of: a physical uplink channel and/or a physical uplink signal satisfying a second predefined condition; a physical uplink channel and/or a physical uplink signal configured to be received by higher layer signaling; a configured grant (CG) physical uplink shared channel (PUSCH); a PUSCH scheduled by a DCI format, wherein the PUSCH is configured or indicated to be transmitted with repetitions; a PUSCH scheduled by a DCI format, wherein the DCI format schedules multiple PUSCHs; a sounding reference signal (SRS); a PUCCH with channel state information (CSI); a PUCCH with hybrid automatic repeat request-acknowledgement (HARQ-ACK); a physical random access channel (PRACH); or a PUCCH with a scheduling request (SR).

In an embodiment of the present disclosure, wherein the first uplink signal includes one or more physical uplink channels, wherein the physical uplink channels include a physical uplink control channel (PUCCH) or a physical uplink shared channel (PUSCH), Wherein the transmitting of the uplink signal in the first time includes: resolving overlapping among the one or more physical uplink channels to determine one or more first physical uplink channels from the one or more physical uplink channels; determining one or more second physical uplink channels from the one or more first physical uplink channels based on one or more of an uplink and downlink frame structure or a cancellation indication, wherein the uplink and downlink frame structure is indicated by one or more of an uplink and downlink configuration or a third DCI format including a slot format indicator (SFI), and the cancellation indication is included in the third DCI format and used for indicating one or more resources where a transmission is cancelled; and transmitting a second physical uplink channel among the one or more second physical uplink channels that satisfies a second predefined condition.

In an embodiment of the present disclosure, wherein the first uplink signal includes one or more physical uplink channels including a PUCCH or a PUSCH, Wherein the transmitting of the uplink signal in the first time includes: determining one or more third physical uplink channels satisfying a second predefined condition from the one or more physical uplink channels; resolving overlapping among the one or more third physical uplink channels to determine one or more fourth physical uplink channels from the one or more third physical uplink channels; determining at least one fourth physical uplink channel to be transmitted from the one or more fourth physical uplink channels based on one or more of an uplink and downlink frame structure or a cancellation indication, wherein the uplink and downlink frame structure is indicated by one or more of an uplink and downlink configuration or the first DCI format including an SFI, and the cancellation indication is included in the second DCI format and used for indicating one or more resources where a transmission is cancelled; and transmitting the at least one fourth physical uplink channel.

In an embodiment of the present disclosure, a terminal in a wireless communication system, comprising: a transceiver; and a controller coupled to the transceiver and configured to: receive configuration information for configuring a parameter related to one or more of cell discontinuous reception (DRX) and/or discontinuous transmission (DTX); receive a downlink control information (DCI) format through a physical downlink control channel (PDCCH); and when the cell DRX and/or DTX is configured, perform a DRX operation on a first downlink signal and/or perform a DTX operation on a first uplink signal, wherein the DRX operation includes receive the first downlink signal in a first time, and the DTX operation includes transmitting the first uplink signal in the first time, wherein the first time is determined based on the configuration information and the DCI format.

FIG. 16 illustrates a structure of a UE according to an embodiment of the disclosure.

As shown in FIG. 16, the UE according to an embodiment may include a transceiver 1610, a memory 1620, and a processor 1630. The transceiver 1610, the memory 1620, and the processor 1630 of the UE may operate according to a communication method of the UE described above. However, the components of the UE are not limited thereto. For example, the UE may include more or fewer components than those described above. In addition, the processor 1630, the transceiver 1610, and the memory 1620 may be implemented as a single chip. Also, the processor 1630 may include at least one processor. Furthermore, the UE of FIG. 16 corresponds to the UE 111, 112, 113, 114, 115, 116 of the FIG. 1, respectively.

The transceiver 1610 collectively refers to a UE receiver and a UE transmitter, and may transmit/receive a signal to/from a base station or a network entity. The signal transmitted or received to or from the base station or a network entity may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the UE. Also, the memory 1620 may store control information or data included in a signal obtained by the UE. The memory 1620 may be a storage medium, such as read-only memory (ROM), random access memory (RAM), a hard disk, a CD-ROM, and a DVD, or a combination of storage media.

The processor 1630 may control a series of processes such that the UE operates as described above. For example, the transceiver 1610 may receive a data signal including a control signal transmitted by the base station or the network entity, and the processor 1630 may determine a result of receiving the control signal and the data signal transmitted by the base station or the network entity.

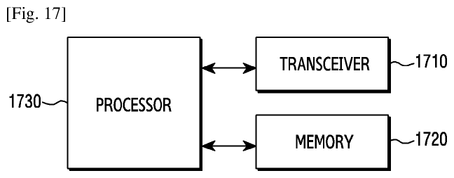

FIG. 17 illustrates a structure of a base station according to an embodiment of the disclosure.

As shown in FIG. 17, the base station according to an embodiment may include a transceiver 1710, a memory 1720, and a processor 1730. The transceiver 1710, the memory 1720, and the processor 1730 of the base station may operate according to a communication method of the base station described above. However, the components of the base station are not limited thereto. For example, the base station may include more or fewer components than those described above. In addition, the processor 1730, the transceiver 1710, and the memory 1720 may be implemented as a single chip. Also, the processor 1730 may include at least one processor. Furthermore, the base station of FIG. 17 corresponds to base station (e.g., BS 101, 102, 103 of FIG. 1).

The transceiver 1710 collectively refers to a base station receiver and a base station transmitter, and may transmit/receive a signal to/from a terminal (UE) or a network entity. The signal transmitted or received to or from the terminal or a network entity may include control information and data. The transceiver 1710 may include a RF transmitter for up-converting and amplifying a frequency of a transmitted signal, and a RF receiver for amplifying low-noise and down-converting a frequency of a received signal. However, this is only an example of the transceiver 1710 and components of the transceiver 1710 are not limited to the RF transmitter and the RF receiver.

Also, the transceiver 1710 may receive and output, to the processor 1730, a signal through a wireless channel, and transmit a signal output from the processor 1730 through the wireless channel.

The memory 1720 may store a program and data required for operations of the base station. Also, the memory 1720 may store control information or data included in a signal obtained by the base station. The memory 1720 may be a storage medium, such as read-only memory (ROM), random access memory (RAM), a hard disk, a CD-ROM, and a DVD, or a combination of storage media.

The processor 1730 may control a series of processes such that the base station operates as described above. For example, the transceiver 1710 may receive a data signal including a control signal transmitted by the terminal, and the processor 1730 may determine a result of receiving the control signal and the data signal transmitted by the terminal.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1.-15. (canceled)

16. A method performed by a terminal in a wireless communication system, the method comprising:
receiving, from a base station, configuration information on a cell discontinuous reception (DRX) and a cell discontinuous transmission (DTX);
identifying an overlapping of uplink (UL) transmissions, wherein the UL transmissions include at least two transmissions among physical uplink control channel (PUCCH) transmissions or physical uplink shared channel (PUSCH) transmissions; and
identifying whether to perform a UL transmission after resolving the overlapping of the UL transmissions, in case that the cell DRX is activated for a serving cell and the UL transmission overlaps with a non-active period of the cell DRX.

17. The method of claim 16, wherein, in case that hybrid automatic repeat request-acknowledgement (HARQ-ACK) information is not multiplexed in a PUCCH, the PUCCH is not transmitted.

18. The method of claim 16, wherein, in case that HARQ-ACK information is not multiplexed in a PUSCH and the PUSCH is not associated with a corresponding physical downlink control channel (PDCCH), the PUSCH is not transmitted.

19. The method of claim 16, further comprising:
receiving, from the base station, at least one semi-persistent scheduling physical downlink shared channel (SPS PDSCH) symbol; and
generating one bit HARQ-ACK information associated with a reception of a SPS PDSCH including the at least one SPS PDSCH symbol,
wherein a cell discontinuous transmission (DTX) is activated for the serving cell, and
wherein the at least one SPS PDSCH symbol does not overlap with a non-active period of the cell DTX.

20. The method of claim 19, wherein the SPS PDSCH overlapping with a PDSCH scheduled by a PDCCH is not decoded.

21. A method performed by a base station in a wireless communication system, the method comprising:
transmitting, to a terminal, configuration information on a cell discontinuous reception (DRX) and a cell discontinuous transmission (DTX),
wherein an uplink (UL) reception is performed after an overlapping of UL receptions is resolved, in case that the cell DRX is activated for a serving cell and the UL reception overlaps with a non-active period of the cell DRX,
wherein the UL receptions include at least two receptions among physical uplink control channel (PUCCH) receptions or physical uplink shared channel (PUSCH) receptions.

22. The method of claim 21, wherein, in case that hybrid automatic repeat request-acknowledgement (HARQ-ACK) information is not multiplexed in a PUCCH, the PUCCH is not received.

23. The method of claim 21, wherein, in case that HARQ-ACK information is not multiplexed in a PUSCH and the PUSCH is not associated with a corresponding physical downlink control channel (PDCCH), the PUSCH is not received.

24. The method of claim 21, further comprising:
transmitting, to the terminal, at least one semi-persistent scheduling physical downlink shared channel (SPS PDSCH) symbol; and
receiving, from the terminal, one bit HARQ-ACK information associated with a transmission of a SPS PDSCH including the at least one SPS PDSCH symbol,
wherein the cell DTX is activated for the serving cell, and
wherein the at least one SPS PDSCH symbol does not overlap with a non-active period of the cell DTX.

25. The method of claim 24, wherein the SPS PDSCH overlapping with a PDSCH scheduled by a PDCCH is not decoded.

26. A terminal comprising:
at least one transceiver;
at least one processor communicatively coupled to the at least one transceiver; and
at least one memory, communicatively coupled to the at least one processor, storing instructions executable by the at least one processor individually or in any combination to cause the terminal to:
receive, from a base station, configuration information on a cell discontinuous reception (DRX) and a cell discontinuous transmission (DTX),
identify an overlapping of uplink (UL) transmissions, wherein the UL transmissions include at least two transmissions among physical uplink control channel (PUCCH) transmissions or physical uplink shared channel (PUSCH) transmissions, and
identify whether to perform a UL transmission after resolving the overlapping of the UL transmissions, in case that the cell DRX is activated for a serving cell and the UL transmission overlaps with a non-active period of the cell DRX.

27. The terminal of claim 26, wherein, in case that hybrid automatic repeat request-acknowledgement (HARQ-ACK) information is not multiplexed in a PUCCH, the PUCCH is not transmitted.

28. The terminal of claim 26, wherein, in case that HARQ-ACK information is not multiplexed in a PUSCH and the PUSCH is not associated with a corresponding physical downlink control channel (PDCCH), the PUSCH is not transmitted.

29. The terminal of claim 26, wherein the instructions further cause the terminal to:
receive, from the base station, at least one semi-persistent scheduling physical downlink shared channel (SPS PDSCH) symbol, and
generate one bit HARQ-ACK information associated with a reception of a SPS PDSCH including the at least one SPS PDSCH symbol,
wherein a cell discontinuous transmission (DTX) is activated for the serving cell, and
wherein the at least one SPS PDSCH symbol does not overlap with a non-active period of the cell DTX.

30. The terminal of claim 29, wherein the SPS PDSCH overlapping with a PDSCH scheduled by a PDCCH is not decoded.

31. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a terminal, configuration information on a cell discontinuous reception (DRX) and a cell discontinuous transmission (DTX),
wherein an uplink (UL) reception is performed after an overlapping of UL receptions is resolved, in case that the cell DRX is activated for a serving cell and the UL reception overlaps with a non-active period of the cell DRX,
wherein the UL receptions include at least two receptions among physical uplink control channel (PUCCH) receptions or physical uplink shared channel (PUSCH) receptions.

32. The base station of claim 31, wherein, in case that hybrid automatic repeat request-acknowledgement (HARQ-ACK) information is not multiplexed in a PUCCH, the PUCCH is not received.

33. The base station of claim 31, wherein, in case that HARQ-ACK information is not multiplexed in a PUSCH and the PUSCH is not associated with a corresponding physical downlink control channel (PDCCH), the PUSCH is not received.

34. The base station of claim 31, wherein the instructions further cause the base station to:
transmit, to the terminal, at least one semi-persistent scheduling physical downlink shared channel (SPS PDSCH) symbol, and
receive, from the terminal, one bit HARQ-ACK information associated with a transmission of a SPS PDSCH including the at least one SPS PDSCH symbol,
wherein the cell DTX is activated for the serving cell, and
wherein the at least one SPS PDSCH symbol does not overlap with a non-active period of the cell DTX.

35. The base station of claim 34, wherein the SPS PDSCH overlapping with a PDSCH scheduled by a PDCCH is not decoded.
